(19) United States
(12) Patent Application Publication
(10) Pub. No.: US 2024/0256772 A1
(43) Pub. Date: Aug. 1, 2024

(54) GESTURE TYPING IN MESSAGING APPLICATIONS WITH CONTEXTUAL DATA

(71) Applicant: Adeia Guides Inc., San Jose, CA (US)

(72) Inventor: Dhananjay Lal, Englewood, CO (US)

(21) Appl. No.: 18/103,986

(22) Filed: Jan. 31, 2023

(51) Int. Cl. G06F 40/274; G06F 3/04883; G06F 3/04886

(52) U.S. Cl. CPC G06F 40/274; G06F 3/04883; G06F 3/04886

(57) ABSTRACT

Systems and methods for improving gesture-based typing in applications where contextual data is used to provide improved word suggestions corresponding to a gesture (i.e., trajectory of hand movement on a digital keyboard) are described. A high-level context is determined by applying techniques such as natural language processing to one or more data categories. Based on the determined high-level context, context specific databases are accessed to obtain additional context specific words. A high priority list (HPL) is generated based on the both the obtain context specific words and the lexicon. The words in the HPL are ranked based on their probability of matching the gesture entered by the user and a top ranked words or words are displayed for input. If suggested word is not accepted by the user, then based on determining a similarity between two sequential gestures, previously suggested words are not repeatedly suggested.

### FIELD OF INVENTION

Embodiments of the present disclosure relate to improved gesture typing in messaging and social media applications where contextual data, which includes user data and other data relevant to the application, is used to provide improved word recommendations that correspond to gestures made in the messaging and social media applications.

### BACKGROUND

“Gesture Typing” or “Shape Writing” has become a common method of text entry into devices that use a capacitive touchscreen for display and input at the same time. Such devices have limited screen size, so the presented keyboard is small, which makes it challenging for the user to enter text, such as in messaging applications. Typical examples of these devices are smartphones, tablets, and smart watches. The basic idea of gesture typing is that users swipe their fingers on the touchscreen keyboard, momentarily stopping at each letter they intend to swipe, but do not lift the finger until the word is complete. The system analyzes the path/trajectory taken by the user in the single swipe, as they move from letter to letter, and presents the best match word in their text dialogue (and a few other possible matches) after their finger is lifted from the touchscreen. This mode of text entry has now become common across all major devices because it allows for much faster text entry while not imposing cognitive load that comes with physically typing out a message by entering each letter on the users (still uses the muscle memory users have for the Qwerty keyboard).

However, gesture typing is far from perfect. It works by finding the highest probability word based on the user finger trajectory from the lexicon/dictionary. Users, however, get imprecise in their trajectory. For example, they may pause at different letters along their path as they get more comfortable with using this feature. In many cases, the highest probability match determined by the system does not reflect the user's intent, perhaps due to their own imprecision (“fat-fingering”). Thus, gesture typing is prone to “input noise” injected by the user.

The problem with inaccurate user input, or input noise, in current methods of gesture typing is that the system may suggest confounding words that are not the intent of the user but have a gesture typing trajectory similar to the intended word. Since some words may have more “confounding words,” based on the trajectory to arrive at these words letter by letter (an unfortunate artifact of the Qwerty keyboard), the system may suggest a confounding word and automatically type that word into the messaging application when the user's intent was to use another word different from the confounding word suggested.

Another problem with current applications is the recognition or pause and use of double letters in a consecutive order. For example, the time for which a user may pause at a certain letter also becomes important as the system may incorrectly analyze such pause(s) as an intent to use the same letter consecutively multiple times, for example, double letters “pp” as in “hopper”, “tt” as in “hotter” or similar. However, a user may be imprecise in their pause and such pauses may be incorrectly analyzed by the system to suggest words, such as words with double letter, when such words are not the intent of the user.

Similarly, another problem occurs if letters on the keyboard occur in a straight line, next to each other, or without change in finger trajectory (in “hotter” t, e and r all lie in the same line). The user may or may not observe a uniform swiping speed, thus confusing the system, that may then offer poorer matches.

These reasons, and others, result in gesture typing being a “stop-start” effort where users may have to resort to manual typing every few words. As such, there is a need for better systems and methods for alleviating some of the deficiencies described above.

### BRIEF DESCRIPTION OF THE DRAWINGS

The various objects and advantages of the disclosure will be apparent upon consideration of the following detailed description, taken in conjunction with the accompanying drawings, in which like reference characters refer to like parts throughout, and in which:

FIG. 1 is a block diagram of a process of improving gesture typing using contextual data, in accordance with some embodiments of the disclosure;

FIG. 2 is a block diagram of an example system for improving gesture typing using contextual data, in accordance with some embodiments of the disclosure;

FIG. 3 is a block diagram of an electronic device used for gesture typing, in accordance with some embodiments of the disclosure;

FIG. 4 is a block diagram of system for improving gesture typing using contextual data, in accordance with some embodiments of the disclosure;

FIG. 5 is a flowchart of a process for improving gesture typing using contextual data, in accordance with some embodiments of the disclosure;

FIG. 6A is an example of text typed into a messaging application of an electronic device, in accordance with some embodiments of the disclosure;

FIG. 6B is an example of composing text in an extended reality application by using the gaze of a user directed at the virtual keyboard;

FIG. 7 depicts examples of word suggestions based on gestures received, in accordance with some embodiments of the disclosure;

FIG. 8 is an example of various natural language processing methods for determining high-level context of a communication, in accordance with some embodiments of the disclosure;

FIG. 9 is a knowledge graph of words relating to a context, in accordance with some embodiments of the disclosure;

FIG. 10 is an example of increasing rank order of a word, in accordance with some embodiments of the disclosure;

FIG. 11 is a block diagram of potential types of contextual data categories used to improve gesture typing, in accordance with some embodiments of the disclosure;

FIG. 12 is a block diagram of potential contextual data sources that may be used to obtain data that is analyzed for determining context, in accordance with some embodiments of the disclosure;

FIG. 13 is a block diagram of potential elimination categories used to eliminate words that may not be a good suggestion for the current user, in accordance with some embodiments of the disclosure;

FIG. 14 is a flowchart of a process for determining similarity between repeated gestures and eliminating previously suggested words based on the determination, in accordance with some embodiments of the disclosure; and

FIG. 15 is a flowchart of a process for determining language proficiency and revising rank ordering of words in the HPL based on the determined language proficiency, in accordance with some embodiments of the disclosure.

### DETAILED DESCRIPTION

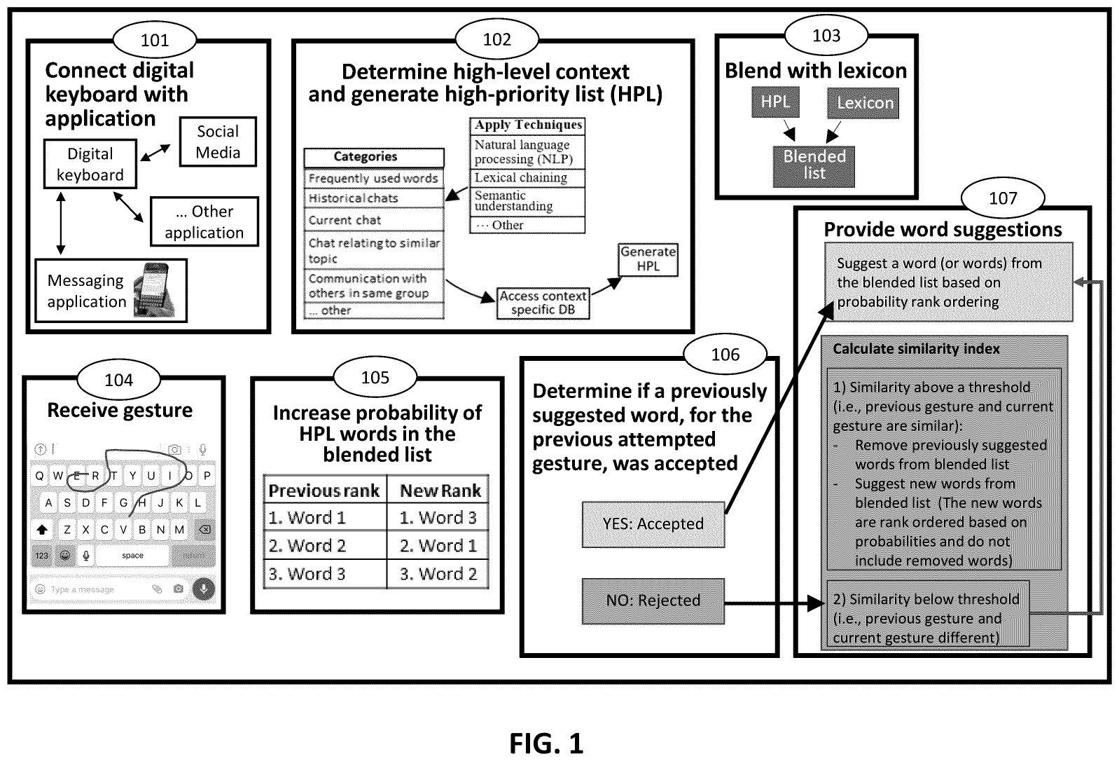

In accordance with some embodiments disclosed herein, some of the above-mentioned limitations are overcome by figures and processes described herein, including in FIGS. 1, 5, 10, and 14-15.

FIG. 1 is a block diagram of a process of improving gesture typing using contextual data, in accordance with some embodiments of the disclosure. The process may be applied to any displayed digital keyboard displayed as part of an application in which a user may trace alphabets or other symbols and icons, including braille, and foreign languages, by touching the displayed digital keyboard, typically by their finger, and moving the finger along a trajectory, including momentarily stopping at one or more letters of the display digital keyboard, to input a word, symbol, pattern, into the display of the application. Examples of applications in which such improved gesture typing can be performed include messaging applications, such as mobile texting applications (e.g., WhatsApp™, Viber™, Signal™, Facebook Messenger™, Microsoft Teams™, Google Hangouts™ etc.), social media applications (e.g., Facebook™, Twitter™, TikTok™, LinkedIn™, Snapchat™, Reddit™, Google+™ etc.), and other applications that may be downloaded on smart phones, smart watches, or tablets.

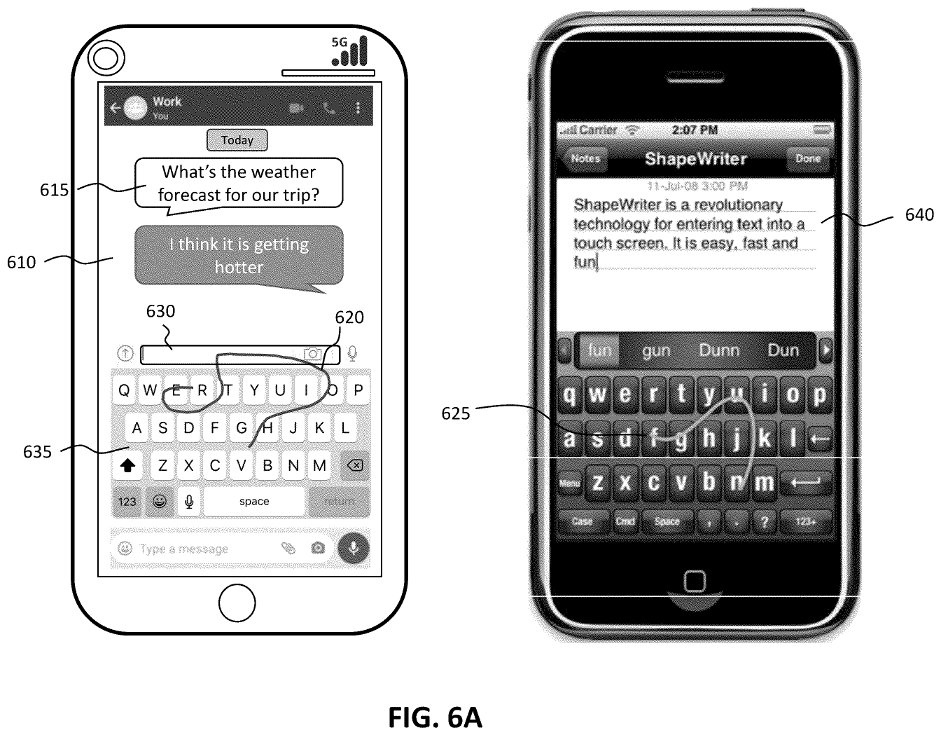

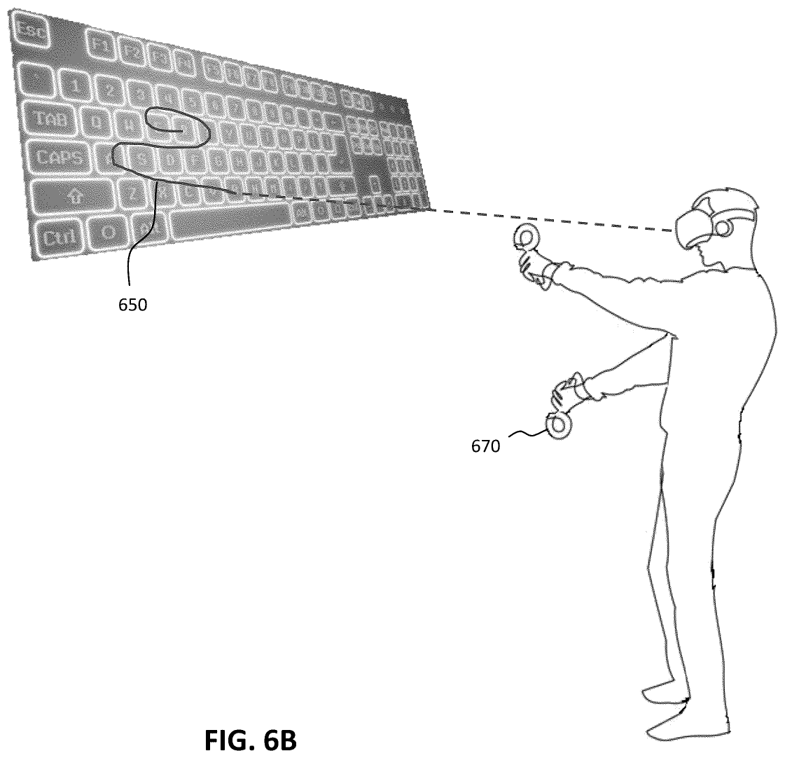

The process may also be applied to any extended reality application, such as augmented reality, mixed reality, virtual reality application, or any other type of virtual application in the metaverse that is capable of tracing hand gestures or gaze across a displayed virtual keyboard in the extended reality or metaverse application. In such extended reality or metaverse application, in one embodiment, the user may make hand gestures either directly with their hand, using a console, by moving sensors attached to their hand, or by moving hands of their avatar in the metaverse, across the displayed virtual keyboard and move their hand, typically their finger, or console, along a trajectory to input a word, symbol, pattern, into the display of the application. In another embodiment, in such extended reality or metaverse application, the user may gaze at the displayed virtual keyboard, such as the keyboard in FIG. 6B. As the user gazes at the keyboard, the user may stop at each letter, or some of the letters, in the intended word for at least a threshold time before moving their gaze to a subsequent letter. The system may be able to track their gaze to a level of accuracy to determine a gazing trajectory to input a word, symbol, pattern, into the display of the virtual application.

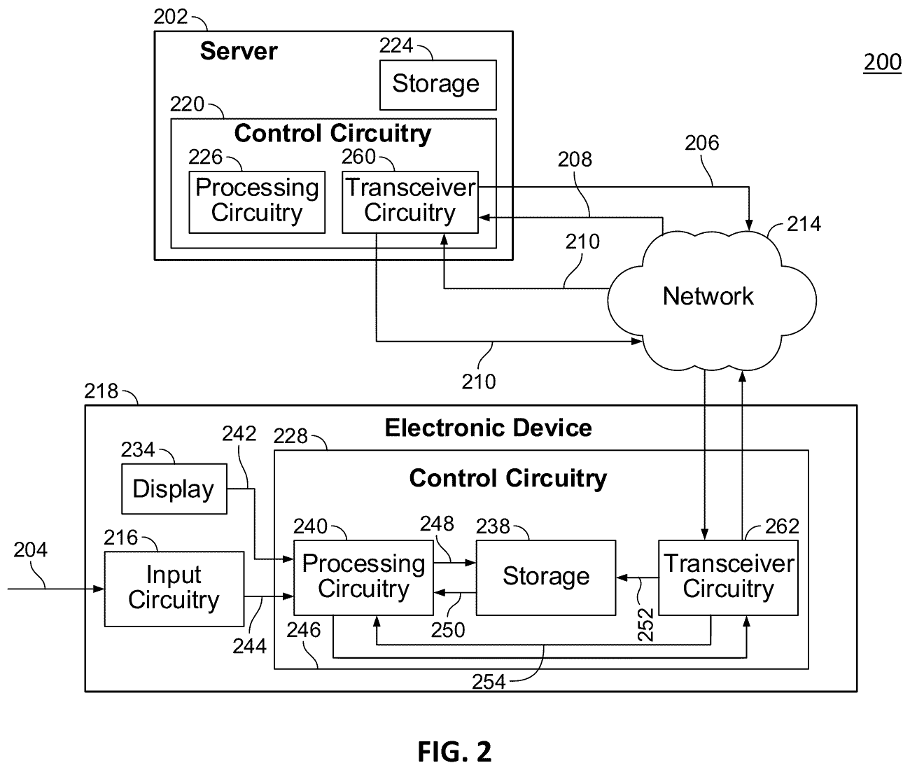

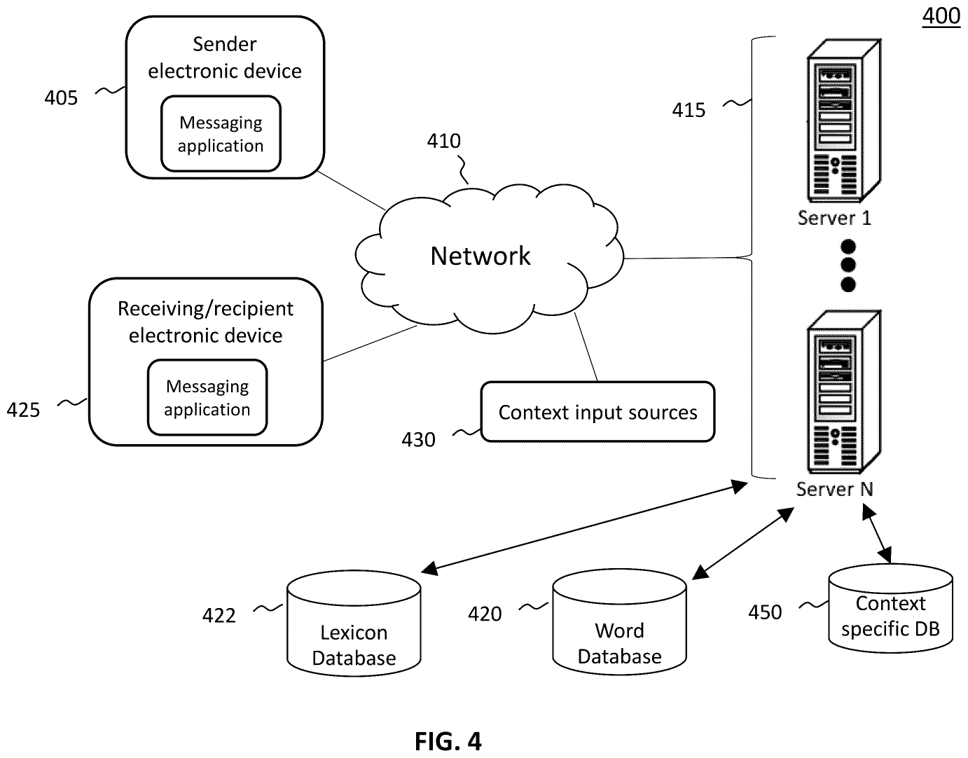

At block 101, a digital keyboard is connected to an application. As mentioned above, the application may be a messaging application, social media application, a mixed reality application, an application in the metaverse, or any application that allows input via a digital or virtual keyboard. The connection between the digital keyboard and the application may be via an API, inter-process communication (IPC) or enabled by the device operating system using methods known in the art to communicate between applications on a device such as intent resolution or service bindings. In some examples, the digital keyboard may be incorporated within the application. The connection may allow communications between the digital keyboard and the application to perform the processes described herein. The digital keyboard may also be directly connected to a server, such as a server described in FIG. 2 or 4, or it may be connected to the application, which may be connected to the server described in FIG. 2 or 4.

In one embodiment, the application, such as the messaging application, invokes the digital keyboard. Processed data, which includes finger trace data that is based on a user's tracing of their finger on the digital keyboard, may be provided to the digital keyboard. In one embodiment, the application may either use an on-device or cloud processor to generate the processed data and provide it to the digital keyboard and in another embodiment, digital keyboard may receive unprocessed data from an application (such as an entire messaging conversation) and then process it using an on-device or cloud processor. In yet another embodiment, a third-party application may be used to generate the processed data. Various forms of bi-directional communications between the digital keyboard and the application, and/or digital keyboard, application, and a server may take place for communicating the processed data and for performing the processes described herein for improved gesture typing.

At block 102, control circuitry, such as control circuitries 220 and/or 228 of the system of FIG. 2, may determine a high-level context and use the high-level context to generate a high-priority list (HPL).

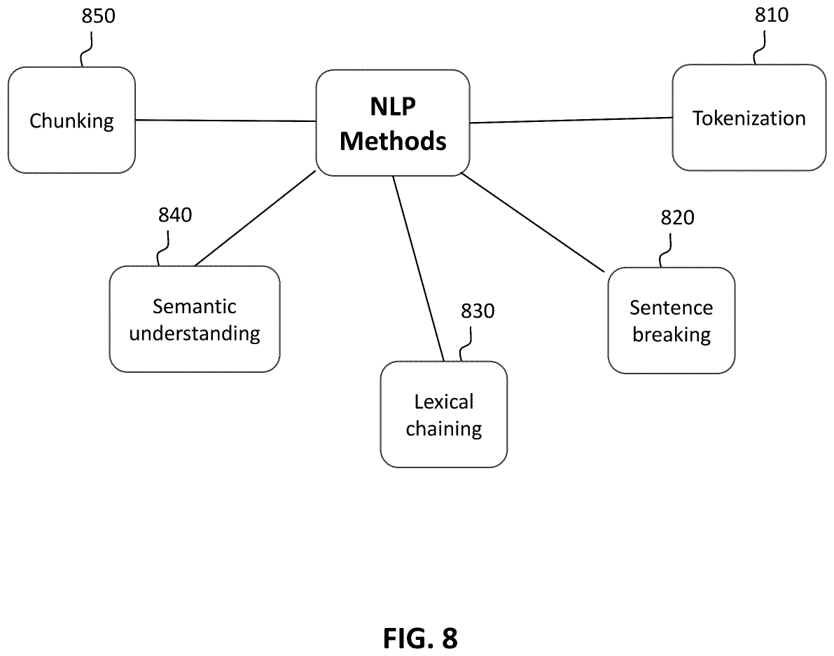

In some embodiments, the process described in block 102 is executed by a) applying techniques such as NLP to contextual data from multiple sources, to b) determining a context using techniques like lexical chaining and/or semantic understanding (or other techniques depicted in FIG. 8), and using the determined context to c) access a context specific database or general database with a query to return context specific words, and d) generate a list of words in a high-priority list that are context specific. These steps in block 102 are described in further detail below.

The techniques mentioned above include natural language processing (NLP), which may apply lexical changing and/or semantic understanding in one stage of a multi-step processing engine to determine related words or context. Although certain techniques have been mentioned, the embodiments are not so limited and any other technique that allows the system to determine the context is contemplated. Such above mentioned techniques, or any additional technique, may be used to determine context based on a communication in the application. For example, the technique may be applied to a messaging application where the data sources may include previous messages, current message, or any other communication using the messaging application between a current user and another user related to the same topic. The control circuitry may determine a context of the communication by applying such technique.

The techniques may also be used to derive context based on other communications and posts of the user using the same or other application. For example, the technique may be applied to another application that the user is not currently using to message, such as the current application being a WhatsApp™ application and a previously used application being a Facebook messenger application, and communications in the currently not being used application, e.g., Facebook Messenger™, may be used to determine context in the current WhatsApp communication. Continuing with the current example, the user may have exchange messaging using the Facebook Messenger™ application with a third user where the messaging related to the context of basketball. The words used in the Facebook™ messaging application may give context and allow the application to determine which words to suggest in the current communication between the current user and a second user that also relates to the basketball.

The techniques may also be used to derive context from applications such as social media applications, extended reality applications, emails, attached documents to emails and other messaging, and voice transcripts from calls and conference calls. For example, the technique may be applied to a social media application where the system analyzes posts generated by the current user or other posts that the user may have liked or commented on to determine context of a current communication.

All or some of the techniques, e.g., natural language processing, lexical changing, semantic understanding, may be used by the control circuitry, such as control circuitries 220 and/or 228 of the system of FIG. 2, to determine the context of a communication. Although not shown, in some embodiments, processing of all or some of the techniques may be performed on-device, such as on the mobile phone used for messaging. In some embodiments, the system may use the NLP technique to convert the spoken language to words. NLP may also be used to determine the commonly used “N-grams” that the user employs in their chats or social media posts, and to analyze the context.

The control circuitries 220 and/or 228 may utilize any of the methods discussed in FIG. 8 to perform NLP. The control circuitries 220 and/or 228 may then perform lexical chaining of the words, i.e., determine a relationship between the words. In some embodiments, artificial intelligence (AI) algorithms or other methods may be used to perform such lexical chaining.

By applying a lexical chaining technique, the control circuitries 220 and/or 228 may identify lexical chains in a text using any lexical resource that relates words by their meaning, such as a dictionary. Since lexical chains represent the lexical cohesion among an arbitrary number of related words, the control circuitries 220 and/or 228 may identify sets of words that are semantically related (i.e., have a sense flow). The control circuitries 220 and/or 228 may also identify relationship between words based on the source text itself and may not use vast databases if deemed not necessary. Using the lexical chaining techniques, the control circuitries 220 and/or 228 may statistically find the most important concepts by looking at structure in the document rather than deep semantic meaning by using generic knowledge bases that contains nouns, and their associations. Such associations may allow the control circuitries 220 and/or 228 to capture relationships between words such as synonym, antonym, and hyperonym.

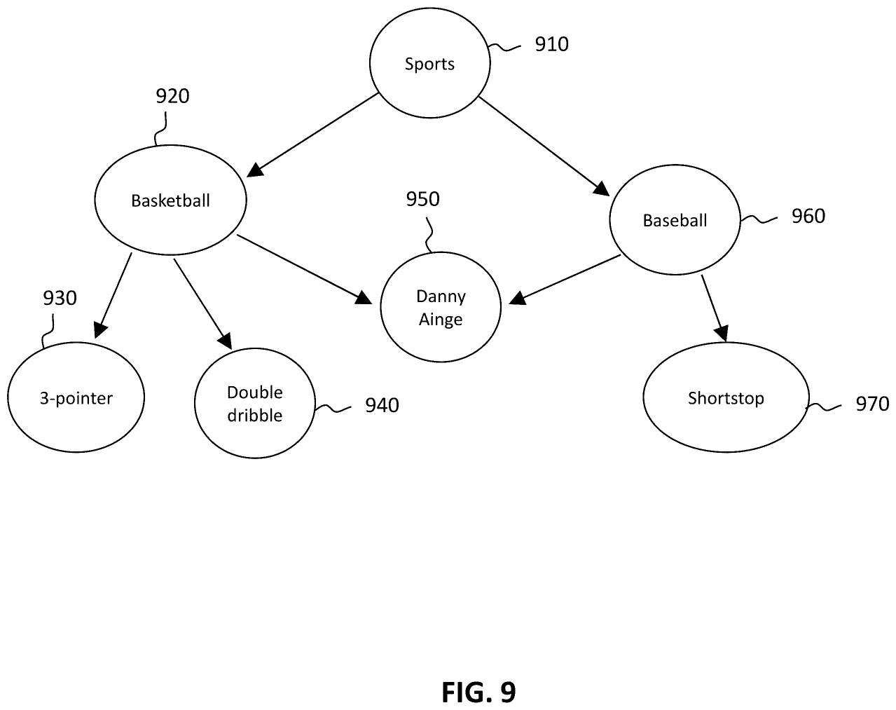

The system may also perform a deeper analysis using semantic understanding techniques. Again, AI algorithms or other methods may be used to perform semantic understanding. Semantic understanding technique may include matching words in a chat with a knowledge graph that provides a deeper relationship between words, such as, for example, the knowledge graph displayed in FIG. 9.

In some embodiments, the techniques (e.g., NLP, which may further use lexical chaining, semantic understanding, or another technique that allows determination of context, and any combination thereof) may be applied on one or more of the data sources, hereafter called categories. These categories include frequently used words, historical chats, current chat, chat relating to similar topic, communication with others in same group. Although some examples of categories on which the techniques may be applied are depicted in block 102, the embodiments are not so limited, and the techniques may be applied to any other content that is related to the user. For example, the techniques may be applied to the user's emails, social media posts, messages or information posted in extended reality applications, attached documents to emails and other messaging, and voice transcripts from calls and conference calls in which the user is involved.

In some embodiments, the techniques may be applied to frequently used words. In this embodiment, the techniques, such as NLP, lexical chaining and/or semantic understanding may be applied to words that the user has used frequently with the same recipient with whom the current message or post is being composed. For example, the control circuitries 220 and/or 228 may perform NLP, by using any of the methods discussed in FIG. 8, use the words obtained from NLP to either get a general context by performing lexical chaining or a deeper context by performing semantic understanding. It may also perform both lexical chaining and semantic understanding.

The techniques may be applied to words that the user has used frequently with any other user who is not the current recipient of the current message or post is being composed. The control circuitry may access the user's messages, posts, and other content to determine which words were frequently used by the user. The control circuitries 220 and/or 228 may review messaging history (e.g., N-grams, typically unigrams, bigrams and trigrams and other emojis that the user has a tendency to use based on history). The control circuitries 220 and/or 228 may then identify high frequency N-grams, i.e., expressions or groups of words for which the user has a very high proclivity. Since this is specific to the user, the person that the user is communicating with is not a restriction in this embodiment. For example, the control circuitries 220 and/or 228 based on applying the technique to the frequently used words may determine that the user likes to use the word “Great Going” frequently. Then, through N-gram scoring (in this case “Great Going” is a bigram”) the system, on receiving a particular user input, automatically provides “Great Going” as a suggestion instead of “Great Found”, since “found” is a confounding word for “going” as they have very similar trajectory in gesturing typing.

In some embodiments, the techniques may be applied to historical chats. In this embodiment, the techniques, such as NLP, lexical chaining and/or semantic understanding may be applied to words that the user has used previously in their chats, e.g., via a messaging application such as WhatsApp™, Viber™, Signal™, Facebook Messenger™, Microsoft Teams™, Google Hangouts™ etc. The techniques may be applied to chats specifically with the current recipient of the current message or to any prior recipient.

In this embodiment, the control circuitries 220 and/or 228, using the techniques, may perform a text analysis to determine context of the last several messaging conversations between the user and the other recipients or correspondent(s) of the current or previous conversation. The control circuitries 220 and/or 228 may then create a list of relevant words based on the semantic knowledge, such as the knowledge graph depicted in FIG. 9. The control circuitries 220 and/or 228 may also create the list of relevant words based on a lexical approach.

In some embodiments, the control circuitries 220 and/or 228 may only use the conversations between the user and the specific person(s) that they are interacting with to create this word list. On the other hand, the system may weigh other things, for example, if the user has had other conversations with different users, within a short time of the current conversation (before current chat), the control circuitries 220 and/or 228 may add these conversations for context analysis. This may give weight to the temporal aspect of messaging conversations, where a user may interact with multiple people or groups on the same context. Similarly, if the people in the current chat are also part of other groups (with more people, but in some cases also less people, i.e., a subset of the current group engaged in chat), the control circuitries 220 and/or 228 may also add some of these conversations for text analysis.

In some embodiments, the control circuitries 220 and/or 228 may only use the conversations within a predetermined period of time, such as within last 30, 17, 10, or another predetermined number of days. In other embodiments, the control circuitries 220 and/or 228 may not restrict the historical chats to any specific time and use all historical chats between the user and the recipient.

In some embodiments, the control circuitries 220 and/or 228 may determine that the topic of conversation relates to a specific event that occurred recently. For example, the topic may relate to the Covid pandemic, or recent earthquake in a specific city, or any other recent event. In this embodiment, the control circuitries 220 and/or 228 may only use historical chats that occurred after the occurrence of the event and consider chats prior to such occurrence irrelevant. For example, since covid 19 started in 2019 (or 2020), historical chats from 2016, 2008, or any date prior to 2019 may not be considered.

The control circuitries 220 and/or 228 may perform the processing either offline after a chat concludes or invoke the processes every time a chat is in progress. The control circuitries 220 and/or 228 may then store the context details of historical chats for future use. For example, the control circuitries 220 and/or 228 may determine based on historical context that the user chats about the weather to the other communicator frequently. The control circuitries 220 and/or 228 may enrich the lexicon with weather-related words in the “High Priority Word List.” In this manner, the control circuitries 220 and/or 228 may generate a higher probability match with the word “hotter” even if the initial probability match with “hotter” is lower than another word based on the user gesture typing action.

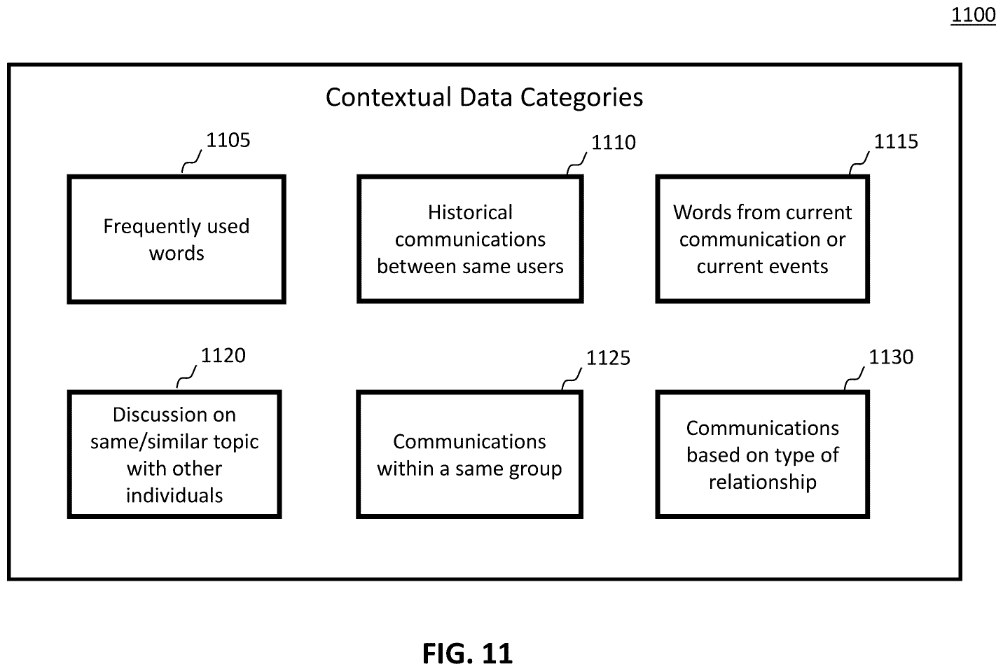

In some embodiments, the techniques may be applied to a current chat. In this embodiment, the techniques, such as NLP, lexical chaining and/or semantic understanding may be applied to words that the user has employed in the current chat prior to providing suggestions for another user gesture. Other categories on which the techniques may be applied, as well as sources from which data for such categories can be obtained, are further discussed in the description of FIGS. 11 and 2 below.

Continuing the discussion of block 102, once the techniques have been applied to the categories, and a context has been determined, the control circuitries 220 and/or 228 may access a specific database to enhance a word list. For example, if the context determined is baseball, then the control circuitries 220 and/or 228 may access a database, if available, that is specific to baseball. From the baseball specific database, the control circuitries 220 and/or 228 may obtain baseball related terms. For example, control circuitries 220 and/or 228 may obtain terms such as double play, AVG—which stands for batting average, RBI—which stands for runs batted in, 3B—which stands for triple play, home run, bunt, strike, innings, no-hitter—which refers to a baseball game in which the pitcher gives up no hits while pitching in a nine-inning game, and other such words and terms of art that have a meaning specific to baseball.

As depicted in block 102, in some embodiments, once the process of applying techniques to categories is performed and the words resulted from the process are enhanced, i.e., more words added via accessing the context specific database (such as database 450 in FIG. 4), a high-priority list is generated. In other embodiments, once the process of applying techniques to categories is performed and the words resulted from the process are determined, the control circuitries 220 and/or 228 may generate the HPL even without accessing a specific database by using only words that were determined by applying techniques to the categories.

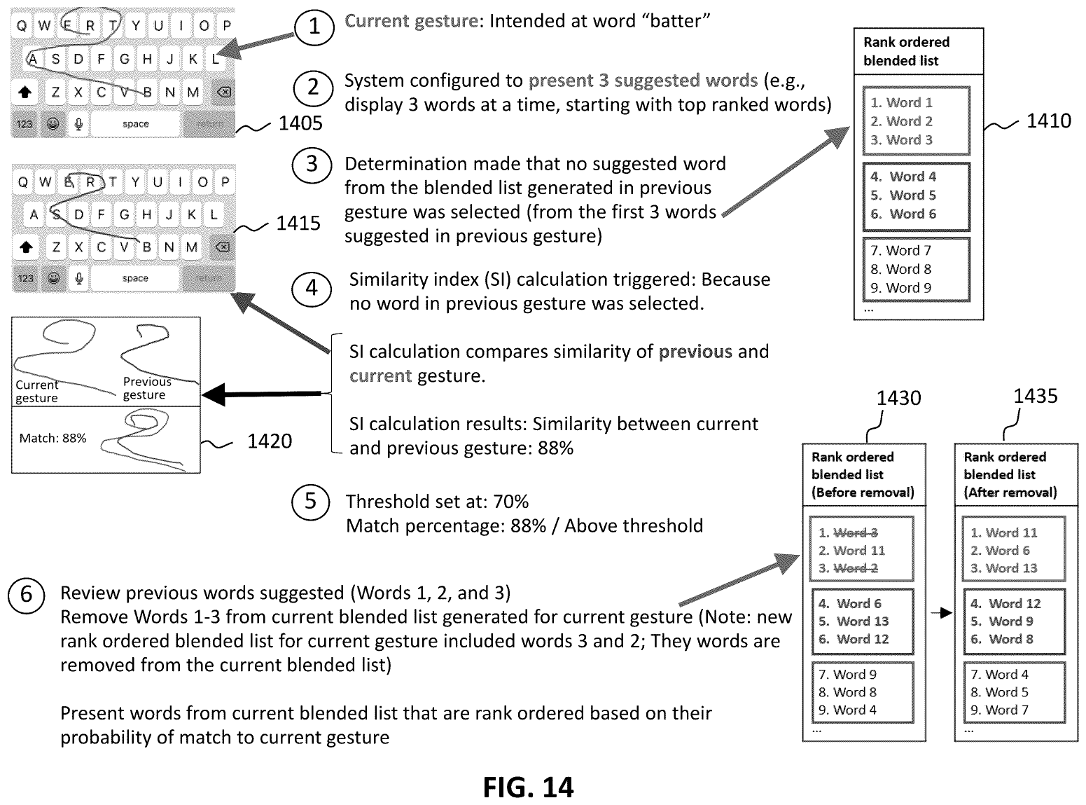

At block 103, the control circuitries 220 and/or 228 may blend the HPL with the lexicon to generate a blended list. As explained earlier, the lexicon is a dictionary, thesaurus, or the like. The blended list may include words from the lexicon (which may be stored in lexicon database 422 of FIG. 4) as well as words from the HPL. In some embodiments, the blended list is ordered in descending order of probability of match to the input gesture from the highest probability match to the lowest probability match. Typically, the system will truncate this calculation when the probability of matching the gesture falls below a threshold, or a threshold number of words with high probability of match to the gesture have been determined. In an illustrative example, the system truncates this calculation at 9 words (as depicted in FIG. 14), or it may continue to find tens and hundreds of words potentially matching or corresponding to the gesture as configured by the system. Taking the example of the blended list that includes 9 words, although the number of words in the blended list can vary and be determined by the system, the control circuitries 220 and/or 228 may rank order all the 9 words based on the probability of each word matching or corresponding to a user gesture (where the gesture is a trajectory of hand or finger movement by a user on a keyboard, while temporarily stopping at certain letters, to enter a word). The control circuitries 220 and/or 228 may rank all the 9 words in an order of the highest probability match to the lowest probability match. Other types of ranking, different order of ranking, are also contemplated.

At block 104, the control circuitries 220 and/or 228 may receive a user gesture. As depicted, in one example, the user gesture may be aimed at a word “batter.” Based on the received gesture, the control circuitries 220 and/or 228, in one embodiment, may enhance the probability of each word in the HPL at the time of gesture-matching by either adding a constant offset or multiplying the initially obtained probability by a factor. The probability relates to the likelihood of the word matching the received gesture, i.e., how probable is the word suggested to match the gesture received. Thus, the control circuitries 220 and/or 228 may enhance each word in the blended list that was in the HPL prior to the blending, i.e., each HPL word before the blending, favoring the HPL over the lexicon in suggesting words to the user.

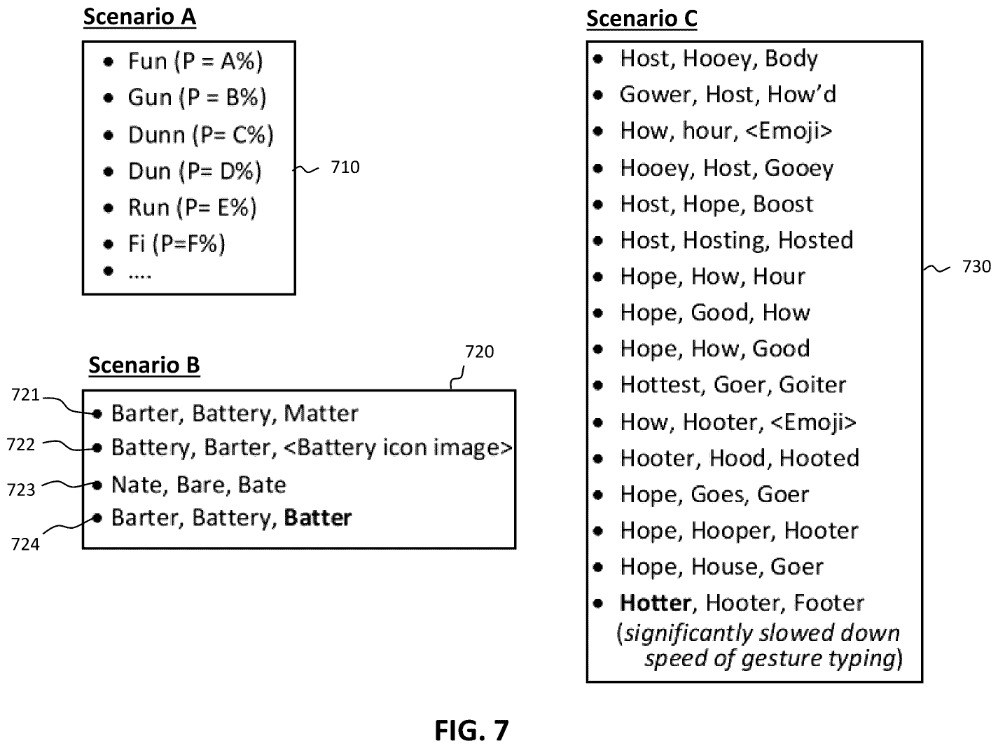

The probability of matching to a certain word in the blended list may also use other polynomial functions. As such, the initially obtained probability for a word on this list based on gesture match, P(w)=X is processed by a transfer function f(X), such that f(X)≥X, making P(w)=f(X). By doing so, the word suggestion is enriched by the context data. For example, the control circuitries 220 and/or 228 by applying the techniques to any of the categories as described in block 102, may determine that the gesture is aimed at the word “batter,” which is contextually related to baseball. As such, the control circuitries 220 and/or 228 may enrich the lexicon by adding baseball terms to the HPL, such as “batter”, “pitcher”, “strike”, “home run” etc., and blend the HPL with the lexicon to generate the blended list, where the blended list would include the enrichments. Then, even if the initial probability of deriving a match with the word “batter” is lower than the words “Battery”, “Barter” or “Bare”, (as depicted in scenario B of FIG. 7), the control circuitries 220 and/or 228 may apply f(X) to the initially derived probability for “batter”, making it a higher match than the other words. In this manner, the control circuitries 220 and/or 228 may suggest “Batter” as the highest probability match.

As further depicted in Scenario B of FIG. 7, a series of attempts to type the word “batter” into a messaging dialog, by a user of a Samsung S20™ 5G/Android™ version 12 phone is illustrated, resulting in the following outcomes:
Barter, Battery, Matter
Battery, Barter, <Battery icon image>
Nate, Bare, Bate
Barter, Battery, Batter
   As such, it may take 4 attempts to yield the desired word (Batter), which had the third highest probability of being the desired word given the gesture input in the 4th attempt. Once the context based HPL is generated and blended into the blended list, which includes words that are rank ordered based on their probability of match to gesture, the word batter is moved up in the rank as the first suggested word to the user.

In other examples, the control circuitries 220 and/or 228 may enrich the blended list with weather-related words if the context determined is weather related. By doing so, the control circuitries 220 and/or 228 may create a higher probability match with the word “hotter” even if the initial probability match with “hotter” is low based on the user gesture typing action. Other examples of words list prior to such enrichments are depicted in scenarios A-C in FIG. 7.

As also depicted in block 105, a previous rank of a word in the lexicon may be enriched to a new rank in the blended list based on context. The new ranks may be listed in descending order of the probability of the candidate word matching the entered gesture. The control circuitries 220 and/or 228 may then display the highest-ranking word to the user such that the word can be accepted by the user and entered into the application, such as into the text of a message being composed in a messaging application. In some embodiments, the control circuitries 220 and/or 228 may automatically input the highest priority word into the application and in other embodiments the control circuitries 220 and/or 228 may seek user approval prior to inputting the highest priority word into the application. In other embodiments, the control circuitries 220 and/or 228 may allow the user to reject the suggested word from being inputted into the application.

At block 106, a determination may be made whether the user accepted or rejected a suggested word in a previous gesture. In one embodiment, the user may have rejected the suggested word in a previous gesture. For example, the user may determine that the suggested word does not match the word they had intended to input in the messaging application by their gesture and as such reject the word.

Determining that the user has rejected (or not accepted) a previously suggested word in a previous gesture may trigger the control circuitries 220 and/or 228 to perform a similarity index calculation. This is to ensure that a word previously suggested, if the current gesture is similar to the previous gesture, is not re-suggested to the user since the user has already rejected it previously. In other words, the control circuitries 220 and/or 228 may determine if a user that rejected a word in the previous attempt is retrying to enter the intended word by inputting a gesture similar to their previous attempt again.

In some embodiments, the similarity analysis is performed to determine if the user is rejecting suggested words and repeatedly entering the same/similar gesture, such as similar trajectory of their finger, on the keyboard in an attempt to get a better matching suggested word. Since each repeated gesture may have a slightly different trajectory, which may be due to the user changing their speed of entering, not tracing the exact same pixels on a display screen of a digital keyboard, or just simple human error which has a margin of deviation from the path, the control circuitries 220 and/or 228 by performing the similarity analysis determines if in fact the subsequently entered gesture is related to the user trying to type in the same word or is it intended for typing in a different word than the earlier suggested word.

To perform the similarity analysis, the gesture input used for word matching may be described as a function of: G=f(Tl, tl) where Tl, is the trajectory (Set of ordered pairs of Angle from a reference axis and length of line segment of swipe, i.e., {(Angle1, Length1), (Angle2, length2), . . . }) and tl may be the time spent at each identified break. In some embodiments, the control circuitries 220 and/or 228 may identify a curve in a trajectory, however in the other embodiments, an assumption may be made that a curve is “piecewise linear”, i.e., a set of line segments.

The control circuitries 220 and/or 228 may calculate a similarity index between the previous trajectory, for which the user has implicitly rejected the suggested words (by choosing to re-input gesture input) and the current trajectory. To calculate this index, the control circuitries 220 and/or 228 may compare the trajectory, but not the time spent on each letter, since a user, in an attempt to retype the word, may enter a gesture at a different speed across multiple attempts to try the same word if they are not being successful. Not accounting for the speed, the trajectory similarity index may, in some embodiments, be calculated by the control circuitries 220 and/or 228 by comparing the distance between 2 trajectories or using another technique that calculates similarity between 2 curves. A person skilled in the art will recognize that several techniques exist for calculating a similarity metric for curved shapes in Euclidean space.

In some embodiments, a point-for-point correspondence between the 2 input trajectories is first determined to calculate the similarity metric. The shorter trajectory points are mapped to the longer trajectory points using the minimum distance criterion, rejecting the points from the longer trajectory that do not lie in the set of points mapped to the shorter trajectory. Then a cumulative measure of distance is calculated across the trajectory such as a sum of the absolute value of distances for each point-for-point correspondence. A root-mean-squared approach may also be used. The similarity index can be calculated by applying a mathematical function that has an inverse relationship with the cumulative measure of distance, such as taking a reciprocal. When the cumulative measure of distance between 2 trajectories is high, then the similarity index, may yield a low value, which is reflective of the input gestures being different and as such are far apart in distance on the keyboard as determined by their trajectories.

On the other hand, when the cumulative measure of distance between two gestures is low, the similarity index is high, which is reflective of the input gestures being similar and as such are close in distance on the keyboard as determined by their trajectories.

In some embodiments, If the similarity index between the previous and current gesture is above a threshold value, then the 2 trajectories are determined to be the same. If the previous and current gestures are determined to be the same, and the user did not accept any suggested word in the previous gesture, the control circuitries 220 and/or 228 may remove the words suggested in the previous gesture from the set of possible matches to display to the user. The control circuitries 220 and/or 228 may then present a new set of matches to the user that are rank ordered based on their probability of match to the current gesture, after removing the potential matches that have been suggested in a previous attempt. In this manner, the control circuitries 220 and/or 228 may avoid user frustration, by removing words that the user may have implicitly rejected (by re-attempting the previous gesture).

To be noted the blended list suggested for the previous gesture and current gesture may be different or same, as further described in description related to FIG. 14. Since the previous gesture and current gesture may have a slightly different trajectory, which may be due to the input noise derived from user changing their speed of entering, not tracing the exact same pixels on a display screen of the digital keyboard, or just simple human error which has a margin of deviation from the path, the control circuitries 220 and/or 228 may generate different blended lists for user gestures intended to yield the same word. The control circuitries 220 and/or 228 may also generate different ranking of words in the blended lists for a previous and current gesture even when the gestures are similar, i.e., similarity index is high. Regardless of whether the two blended lists of the previous and current gestures are same or different, the control circuitries 220 and/or 228 may remove those words from the current blended list generated for the current gesture that were suggested to the user in the previous attempt and the user had not accepted any words in that attempt. Doing so would ensure that words not accepted by the user for the previous gesture are not suggested again. The control circuitries 220 and/or 228 may then suggest new words based on their probability rank ordering to match the current gesture after removing the previously suggested words from the blended list.

As depicted in block 107, if the two gestures are determined to be similar, then previously suggested words are removed, and words from the blended list, without the previously rejected word(s), that are rank ordered based on their probability to match the current or second gesture, are suggested.

One example of similarity may be in a messaging application, such as in a real time chat, where the system determines that the user is re-attempting gesture typing the same word (they ignored the word suggestions of the first attempt, AND the similarity index of the second attempt with the first attempt is high). When such a determination is made, the control circuitry may rejects/ignores the words that were presented in the first attempt, i.e., previously suggested words that were rejected by the user, and suggests words rank ordered based on probability of match to the second attempt, from a new blended list that is generated for the second attempt (which is the current attempt). In this manner, it improves the chance of giving the user their desired word.

Referring to 2) in block 107, similarity between current and previous gesture may be below a threshold which relates to determining that current and previous gestures are different. In other words, the difference in gestures relates to the previous gesture likely being associated with a different word than a current gesture. As such, for the current gesture, as pointed by the arrow from 2), a word (or words) from the blended list based on their priority rank ordering are presented.

FIG. 2 is a block diagram of an example system for improving gesture typing using contextual data, in accordance with some embodiments of the disclosure.

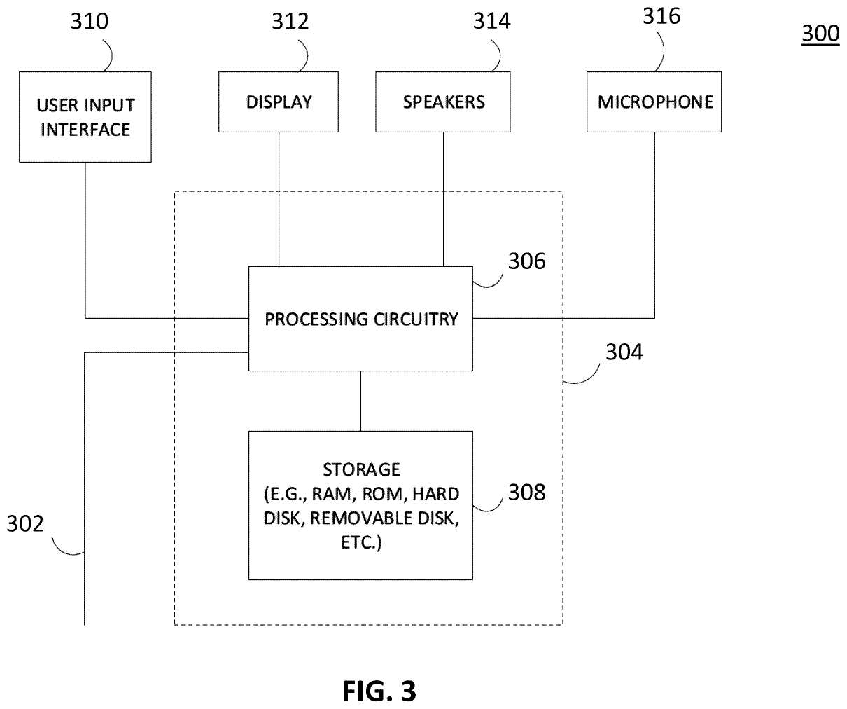

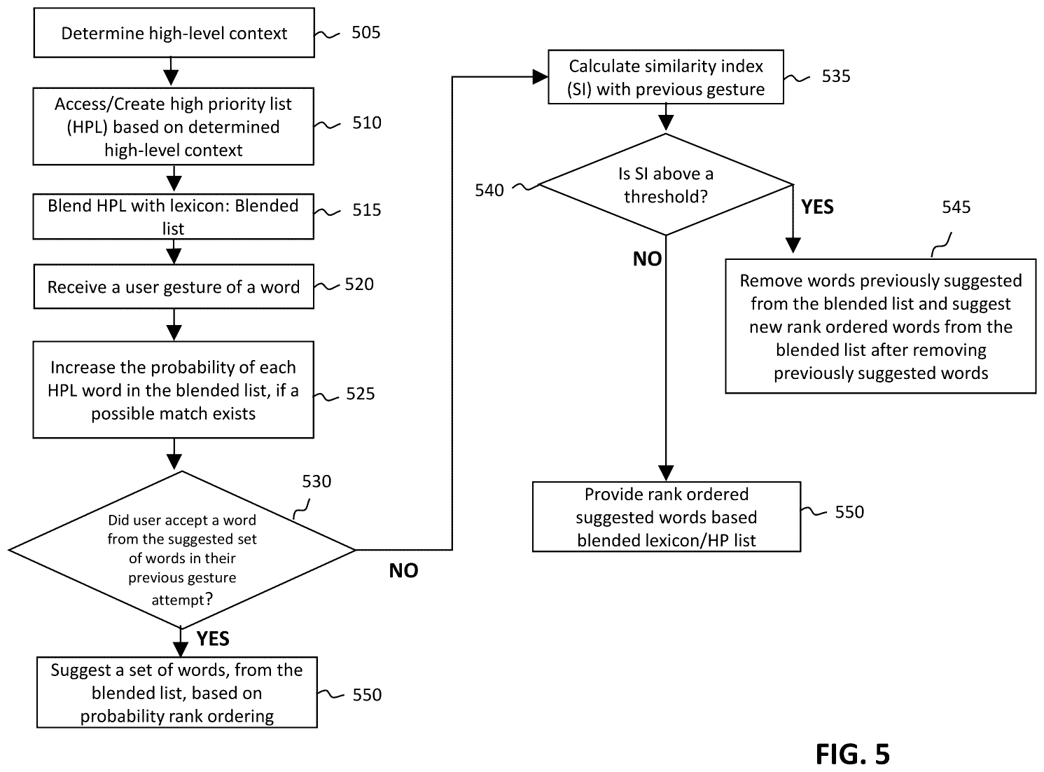

FIGS. 2 and 3 also describe example devices, systems, servers, and related hardware that may be used to implement processes, functions, and functionalities described at least in relation to FIGS. 1, 5, 10, and 14-15. Further, FIGS. 2 and 3 may also be used for connecting a digital keyboard with an application, such as a messaging, social media, or extended reality application, authorizing communications between the digital keyboard and the application, allowing communications between the digital keyboard and the application, determining a high-level context, where such determination includes applying techniques to data categories obtained from a plurality of sources (such as depicted in blocks 102 of FIG. 1 and 505 of FIG. 5), accessing context specific databases (such as database 450 in FIG. 4), enhancing a lexicon based on words obtained from the context specific databases, generating an HPL, blending the HPL with the lexicon (which may be stored in lexicon database 422 of FIG. 4) to generate a blended list, receiving and processing/analyzing the received gesture and finding matches in the blended list, increasing the probability of words in the HPL based on the received gesture, suggesting higher ranked, or highest ranked word in the blended list to the user, determining if any suggested word from the previous attempt was accepted by the user, calculating a similarity index if the suggested words were not accepted by the user, suggesting words from a new blended list having removed previously rejected words if a subsequent gesture after the suggested words not being accepted by the user are within a similarity threshold of the earlier gesture, determining user's word usage patterns, including frequently used words using machine learning (ML), determining likelihood of match between a suggested word and gesture using AI, determining the context based on using AI, and performing functions related to all other processes and features described herein.

In some embodiments, one or more parts of, or the entirety of system 200, may be configured as a system implementing various features, processes, functionalities and components of figures described herein, including FIGS. 1, 5, 10, and 14-15. Although FIG. 2 shows a certain number of components, in various examples, system 200 may include fewer than the illustrated number of components and/or multiples of one or more of the illustrated number of components. In addition, components that are displayed on separate devices may also be incorporated within a single device to perform the same operation.

System 200 is shown to include a computing device 218, a server 202 and a communication network 214. It is understood that while a single instance of a component may be shown and described relative to FIG. 2, additional instances of the component may be employed. For example, server 202 may include, or may be incorporated in, more than one server. Similarly, communication network 214 may include, or may be incorporated in, more than one communication network. Server 202 is shown communicatively coupled to computing device 218 through communication network 214. While not shown in FIG. 2, server 202 may be directly communicatively coupled to computing device 218, for example, in a system absent or bypassing communication network 214.

Communication network 214 may comprise one or more network systems, such as, without limitation, an internet, LAN, WIFI or other network systems suitable for audio processing applications. In some embodiments, system 200 excludes server 202, and functionality that would otherwise be implemented by server 202 is instead implemented by other components of system 200, such as one or more components of communication network 214. In still other embodiments, server 202 works in conjunction with one or more components of communication network 214 to implement certain functionality described herein in a distributed or cooperative manner. Similarly, in some embodiments, system 200 excludes computing device 218, and functionality that would otherwise be implemented by computing device 218 is instead implemented by other components of system 200, such as one or more components of communication network 214 or server 202 or a combination. In still other embodiments, computing device 218 works in conjunction with one or more components of communication network 214 or server 202 to implement certain functionality described herein in a distributed or cooperative manner.

Computing device 218 includes control circuitry 228, display 234 and input circuitry 216. Control circuitry 228 in turn includes transceiver circuitry 262, storage 238 and processing circuitry 240. In some embodiments, computing device 218 or control circuitry 228 may be configured as electronic device 300 of FIG. 3.

Server 202 includes control circuitry 220 and storage 224. Each of storages 224 and 238 may be an electronic storage device. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 4D disc recorders, digital video recorders (DVRs, sometimes called personal video recorders, or PVRs), solid state devices, quantum storage devices, gaming consoles, gaming media, or any other suitable fixed or removable storage devices, and/or any combination of the same. Each storage 224, 238 may be used to store various types of content (e.g., algorithms for techniques to be used, identification of categories on which the techniques are to be applied, data from the categories, such as frequently used words, historical chats current chat etc., data relating to context determined from applying the techniques to the categories, words and other data obtained from accessing a context specific database (such as database 450 in FIG. 4), a high priority list, probabilities of award in the high priority list to a received gesture, a blended list that includes the high priority list and the lexicon, ranking within the blended list, received gesture, data relating to which suggested words were accepted and rejected by a user, calculations and values of a similarity index, thresholds related to a similarity index, configurations of a system relating to a quantity or limit of number of words that are to be suggested at a time to a user, and AI and ML algorithms). Non-volatile memory may also be used (e.g., to launch a boot-up routine, launch an app, render an app, and other instructions). Cloud-based storage may be used to supplement storages 224, 238 or instead of storages 224, 238. In some embodiments, data relating to algorithms for techniques to be used, identification of categories on which the techniques are to be applied, data from the categories, such as frequently used words, historical chats current chat etc., data relating to context determined from applying the techniques to the categories, words and other data obtained from accessing a context specific database, a high priority list, ranking within the high priority list, probabilities of award in the high priority list to a received gesture, a blended list that includes the high priority list and the lexicon, received gesture, data relating to which suggested words were accepted and rejected by a user, calculations and values of a similarity index, thresholds related to a similarity index, configurations of a system relating to a quantity or limit of number of words that are to be suggested at a time to a user, and AI and ML algorithms, and data relating to all other processes and features described herein, may be recorded and stored in one or more of storages 212, 238.

In some embodiments, control circuitries 220 and/or 228 executes instructions for an application stored in memory (e.g., storage 224 and/or storage 238). Specifically, control circuitries 220 and/or 228 may be instructed by the application to perform the functions discussed herein. In some implementations, any action performed by control circuitries 220 and/or 228 may be based on instructions received from the application. For example, the application may be implemented as software or a set of executable instructions that may be stored in storage 224 and/or 238 and executed by control circuitries 220 and/or 228. In some embodiments, the application may be a client/server application where only a client application resides on computing device 218, and a server application resides on server 202.

The application may be implemented using any suitable architecture. For example, it may be a stand-alone application wholly implemented on computing device 218. In such an approach, instructions for the application are stored locally (e.g., in storage 238), and data for use by the application is downloaded on a periodic basis (e.g., from an out-of-band feed, from an internet resource, or using another suitable approach). Control circuitry 228 may retrieve instructions for the application from storage 238 and process the instructions to perform the functionality described herein. Based on the processed instructions, control circuitry 228 may determine a type of action to perform in response to input received from input circuitry 216 or from communication network 214. For example, in response to receiving a gesture, words from a HPL may be suggested based on their match to the gesture. It may also perform steps of processes described in FIGS. 1, 5, 10, and 14-15, including generating HPL, ranking words in the HTML based on their probability of match to the gesture, and displaying a highest ranked were from the HPL to the user or automatically inputting the word into a composing box of a messaging application.

In client/server-based embodiments, control circuitry 228 may include communication circuitry suitable for communicating with an application server (e.g., server 202) or other networks or servers. The instructions for carrying out the functionality described herein may be stored on the application server. Communication circuitry may include a cable modem, an Ethernet card, or a wireless modem for communication with other equipment, or any other suitable communication circuitry. Such communication may involve the internet or any other suitable communication networks or paths (e.g., communication network 214). In another example of a client/server-based application, control circuitry 228 runs a web browser that interprets web pages provided by a remote server (e.g., server 202). For example, the remote server may store the instructions for the application in a storage device. The remote server may process the stored instructions using circuitry (e.g., control circuitry 228) and/or generate displays. Computing device 218 may receive the displays generated by the remote server and may display the content of the displays locally via display 234. This way, the processing of the instructions is performed remotely (e.g., by server 202) while the resulting displays, such as the display windows described elsewhere herein, are provided locally on computing device 218. Computing device 218 may receive inputs from the user via input circuitry 216 and transmit those inputs to the remote server for processing and generating the corresponding displays. Alternatively, computing device 218 may receive inputs from the user via input circuitry 216 and process and display the received inputs locally, by control circuitry 228 and display 234, respectively.

Server 202 and computing device 218 may transmit and receive content and data such as physiological data and cybersickness scores and input from primary devices and secondary devices, such as XR devices. Control circuitry 220, 228 may send and receive commands, requests, and other suitable data through communication network 214 using transceiver circuitry 260, 262, respectively. Control circuitry 220, 228 may communicate directly with each other using transceiver circuits 260, 262, respectively, avoiding communication network 214.

It is understood that computing device 218 is not limited to the embodiments and methods shown and described herein. In nonlimiting examples, computing device 218 may be an electronic device, a personal computer (PC), a laptop computer, a tablet computer, a WebTV box, a personal computer television (PC/TV), a PC media server, a PC media center, a handheld computer, a mobile telephone, a smartphone, a virtual, augmented, or mixed reality device, or a device that can perform function in the metaverse, or any other device, computing equipment, or wireless device, and/or combination of the same capable of suitably for improving gesture based-typing, including generating HPL, ranking words in the HPL based on their probability of match to the gesture, and displaying a highest ranked were from the HPL to the user or automatically inputting the word into a composing box of a messaging application.

Control circuitries 220 and/or 218 may be based on any suitable processing circuitry such as processing circuitry 226 and/or 240, respectively. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some embodiments, processing circuitry may be distributed across multiple separate processors, for example, multiple of the same type of processors (e.g., two Intel Core i9 processors) or multiple different processors (e.g., an Intel Core i7 processor and an Intel Core i9 processor). In some embodiments, control circuitries 220 and/or control circuitry 218 are configured for connecting a digital keyboard with an application, such as a messaging, social media, or extended reality application, authorizing communications between the digital keyboard and the application, allowing communications between the digital keyboard and the application, determining a high-level context, where such determination includes applying techniques to data categories obtained from a plurality of sources (such as depicted in blocks 102 of FIG. 1 and 505 of FIG. 5), accessing context specific databases, enhancing a lexicon based on words obtained from the context specific databases, generating an HPL, blending the HPL with the lexicon to generate a blended list, receiving and processing/analyzing the received gesture, increasing the probability of words in the HPL based on the received gesture, rank ordering the blended list and suggesting higher ranked, or highest ranked word to the user, determining if a suggested word from the blended list is accepted by the user, calculating a similarity index if suggested words are not accepted by the user in an attempt, suggesting words from a new blended list having removed previously rejected words if a subsequent gesture after the suggested words not being accepted by the user are within a similarity threshold of the earlier gesture, determining user's word usage patterns, including frequently used words using machine learning (ML), determining likelihood of match between a suggested word and gesture using AI, determining the context based on using AI, and performing functions related to all other processes and features described herein.

Computing device 218 receives a user input 204 at input circuitry 216. For example, computing device 218 may receive a gesture and suggest words that match the gesture, wherein a process for such improved gesture based-typing includes generating HPL, blending the HPL with a lexicon, increasing the probability of HPL words in the blended list, ranking words in the blended list based on their probability of match to the gesture and displaying a highest ranked words to the user or automatically inputting the word into a composing box of a messaging application and all processes described in FIGS. 1 and 5.

Transmission of user input 204 to computing device 218 may be accomplished using a wired connection, such as an audio cable, USB cable, ethernet cable or the like attached to a corresponding input port at a local device, or may be accomplished using a wireless connection, such as Bluetooth, WIFI, WiMAX, GSM, UTMS, CDMA, TDMA, 3G, 4G, 4G LTE, or any other suitable wireless transmission protocol. Input circuitry 216 may comprise a physical input port such as a 3.5 mm audio jack, RCA audio jack, USB port, ethernet port, or any other suitable connection for receiving audio over a wired connection or may comprise a wireless receiver configured to receive data via Bluetooth, WIFI, WiMAX, GSM, UTMS, CDMA, TDMA, 3G, 4G, 4G LTE, or other wireless transmission protocols.

Processing circuitry 240 may receive input 204 from input circuit 216. Processing circuitry 240 may convert or translate the received user input 204 that may be in the form of voice input into a microphone, or movement or gestures to digital signals. In some embodiments, input circuit 216 performs the translation to digital signals. In some embodiments, processing circuitry 240 (or processing circuitry 226, as the case may be) carries out disclosed processes and methods. For example, processing circuitry 240 or processing circuitry 226 may perform processes as described in FIGS. 1, 5, 10, and 14-15.

FIG. 3 is a block diagram of an electronic device used for performing gesture typing, in accordance with some embodiments of the disclosure. In some embodiments, the equipment device 300, is the same equipment device 202 of FIG. 2. The equipment device 300 may receive content and data via input/output (I/O) path 302. The I/O path 302 may provide audio content (e.g., such as in the speakers of an XR headset). The control circuitry 304 may be used to send and receive commands, requests, and other suitable data using the I/O path 302. The I/O path 302 may connect the control circuitry 304 (and specifically the processing circuitry 306) to one or more communications paths or links (e.g., via a network interface), any one or more of which may be wired or wireless in nature. Messages and information described herein as being received by the equipment device 300 may be received via such wired or wireless communication paths. I/O functions may be provided by one or more of these communications paths or intermediary nodes but are shown as a single path in FIG. 3 to avoid overcomplicating the drawing.

The control circuitry 304 may be based on any suitable processing circuitry such as the processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 or i9 processor).

In client-server-based embodiments, the control circuitry 304 may include communications circuitry suitable for connecting a digital keyboard with an application, such as a messaging, social media, or extended reality application, authorizing communications between the digital keyboard and the application, allowing communications between the digital keyboard and the application, determining a high-level context, where such determination includes applying techniques to data categories obtained from a plurality of sources (such as depicted in blocks 102 of FIG. 1 and 505 of FIG. 5), accessing context specific databases, enhancing a lexicon based on words obtained from the context specific databases, generating an HPL, blending the HPL with the lexicon to generate a blended list, receiving and processing/analyzing the received gesture, increasing the probability of words in the HPL based on the received gesture, suggesting higher ranked, or highest ranked word in the HPL to the user, determining if a suggested word from the HPL is accepted by the user, calculating a similarity index if a suggested word is not accepted by the user, suggesting words from a new blended list having removed previously rejected words if a subsequent gesture after the suggested word not being accepted by the user is within a similarity threshold an earlier gesture, determining user word usage, including frequently used words using machine learning (ML), determining likelihood of match between a suggested word and gesture using AI, determining the context based on using AI, and performing functions related to all other processes and features described herein.

The instructions for carrying out the above-mentioned functionality may be stored on one or more servers. Communications circuitry may include a cable modem, an integrated service digital network (ISDN) modem, a digital subscriber line (DSL) modem, a telephone modem, ethernet card, or a wireless modem for communications with other equipment, or any other suitable communications circuitry. Such communications may involve the internet or any other suitable communications networks or paths. In addition, communications circuitry may include circuitry that enables peer-to-peer communication of primary equipment devices, or communication of primary equipment devices in locations remote from each other (described in more detail below).

Memory may be an electronic storage device provided as the storage 308 that is part of the control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid-state devices, quantum-storage devices, gaming consoles, gaming media, or any other suitable fixed or removable storage devices, and/or any combination of the same. The storage 308 may be used to store various types of content, (e.g., algorithms for techniques to be used, identification of categories on which the techniques are to be applied, data from the categories, such as frequently used words, historical chats current chat etc., data relating to context determined from applying the techniques to the categories, words and other data obtained from accessing a context specific database (such as database 450 in FIG. 4), a high priority list, ranking within the high priority list, probabilities of award in the high priority list to a received gesture, a blended list that includes the high priority list and the lexicon, received gesture, data relating to which suggested words were accepted and rejected by a user, calculations and values of a similarity index, thresholds related to a similarity index, configurations of a system relating to a quantity or limit of number of words that are to be suggested at a time to a user, and AI and ML algorithms). Cloud-based storage, described in relation to FIG. 3, may be used to supplement the storage 308 or instead of the storage 308.

The control circuitry 304 may include audio generating circuitry and tuning circuitry, such as one or more analog tuners, audio generation circuitry, filters or any other suitable tuning or audio circuits or combinations of such circuits. The control circuitry 304 may also include scaler circuitry for upconverting and down converting content into the preferred output format of the electronic device 300. The control circuitry 304 may also include digital-to-analog converter circuitry and analog-to-digital converter circuitry for converting between digital and analog signals. The tuning and encoding circuitry may be used by the electronic device 300 to receive and to display, to play, or to record content. The circuitry described herein, including, for example, the tuning, audio generating, encoding, decoding, encrypting, decrypting, scaler, and analog/digital circuitry, may be implemented using software running on one or more general purpose or specialized processors. If the storage 308 is provided as a separate device from the electronic device 300, the tuning and encoding circuitry (including multiple tuners) may be associated with the storage 308.

The user may utter instructions to the control circuitry 304, which are received by the microphone 316. The microphone 316 may be any microphone (or microphones) capable of detecting human speech. The microphone 316 is connected to the processing circuitry 306 to transmit detected voice commands and other speech thereto for processing. In some embodiments, voice assistants (e.g., Siri, Alexa, Google Home and similar such voice assistants) receive and process the voice commands and other speech.

The electronic device 300 may include an interface 310. The interface 310 may be any suitable user interface, such as a remote control, mouse, trackball, keypad, keyboard, touchscreen, touchpad, stylus input, joystick, or other user input interfaces. A display 312 may be provided as a stand-alone device or integrated with other elements of the electronic device 300. For example, the display 312 may be a touchscreen or touch-sensitive display o which a user may drag their finger and the path taken, i.e., the trajectory, may be used to determine the gesture. When the interface 310 is configured with a screen, such a screen may be one or more monitors, a television, a liquid crystal display (LCD) for a mobile device, active-matrix display, cathode-ray tube display, light-emitting diode display, organic light-emitting diode display, quantum-dot display, or any other suitable equipment for displaying visual images. In some embodiments, the interface 310 may be HDTV-capable. In some embodiments, the display 312 may be a 3D display. The speaker (or speakers) 314 may be provided as integrated with other elements of electronic device 300 or may be a stand-alone unit. In some embodiments, the display 312 may be outputted through speaker 314.

The equipment device 300 of FIG. 3 can be implemented in system 200 of FIG. 2 as primary equipment device 202, but any other type of user equipment suitable for allowing communications between two separate user devices for performing the functions related to implementing machine learning (ML) and artificial intelligence (AI) algorithms, and all the functionalities discussed associated with the figures mentioned in this application.

FIG. 4 is a block diagram of system for improving gesture typing using contextual data, in accordance with some embodiments of the disclosure. In some embodiments, the system 400 includes one or more sending electronic devices 405, one or more of receiving electronic devices 425, one or more servers 415, and one or more databases, such as a word database 420, lexicon database 422, and a context specific database 450, and content input sources 430, that are communicatively connected to each other via network 410.

In one embodiment, sender electronic device 405 and the receiving electronic device 425 include a messaging application. The messaging application may be downloaded by the user of the electronic device or may have been previously installed as a factory setting on the electronic device. The messaging application includes a graphical user interface that can be used to communicate between sending and receiving electronic devices. The messaging application includes also includes a digital keyboard, such as a digital QWERTY keyboard, that is displayed when the application is launched or active. Users of the messaging application are able to compose the message, create groups, create contacts, visually see from whom messages are received and to whom a message is being sent, attach images and voice notes and perform standard messaging platform operations. Some examples of such messaging applications include WhatsApp™, Google Hangouts™, WeChat™, Viber™, Facebook Messenger™, Instagram™, Microsoft Teams™, Zoom™, Yammer™, Slack™, PlayStation™, and Xbox™. Users of the messaging application are also able to compose the message by dragging their finger across the digital keyboard. The users may use varying speeds of dragging along a path or trajectory to spell out a word by using the dragging or tracing type gesture.

In one embodiment, the sender electronic device communicates with the server via network 410. Using this communication channel, the server is able to get notification of a message being composed in the sender electronic device or receive a request to transmit a message to the receiving electronic device. Using this communication channel, the server is also able to monitor in real-time the tracing or navigation of the finger as it is dragged across the digital keyboard. For example, even while the finger is still being dragged and has not come to a stop signifying the end of the path, data of all the letters the finger has navigated over so far can be obtained in real time by the server.

In some embodiments, the server may access the word database 420 that includes a plurality of words that are rank ordered based on their match probability to the received gesture and suggest words as the user continues to provide the gesture. In other embodiments, the server may wait until the gesture is completed to access the blended list database that includes a plurality of words that are rank ordered based on their match probability and suggest words to the user.

In some embodiments, after determining the context, the control circuitry, such as the control circuitry in FIG. 2, may access the context specific database 450 to obtain context specific words. These context specific words may be used to create the HPL that enhances the lexicon to yield a blended list. The system 400 may be used to execute processes, such as those described in FIGS. 1, 5, 10, and 14-15.

In some embodiments, each time a gesture is received, including if the gesture is similar to a previous gesture, such as the gesture being 88% similar to a previous gesture as depicted in FIG. 14, a new blended list is generated.

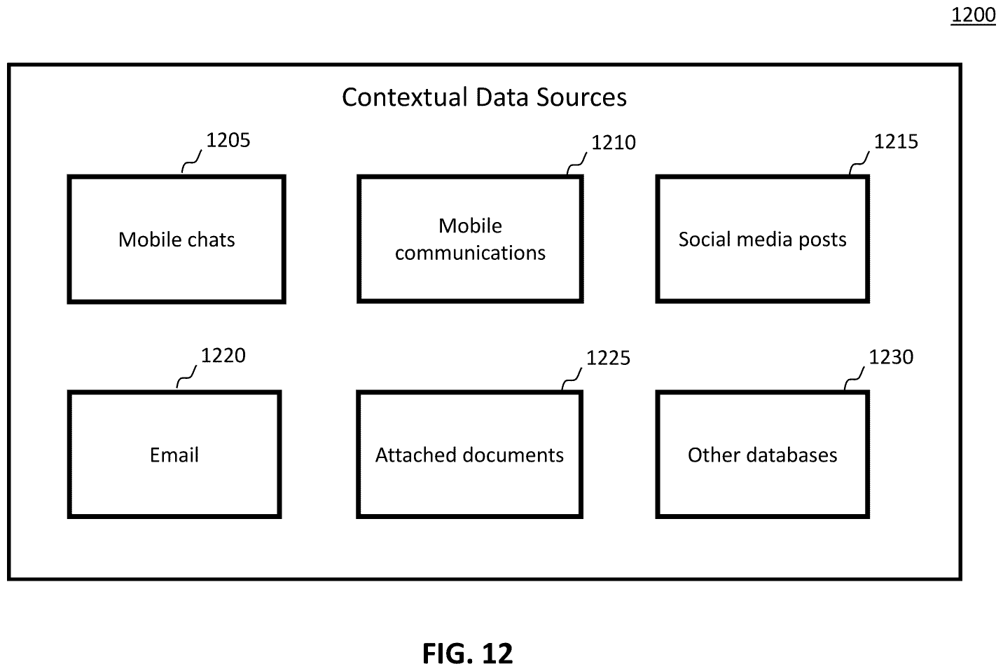

FIG. 5 is a flowchart of a process for improving gesture typing using contextual data, in accordance with some embodiments of the disclosure. In some embodiments, at block 505, a high-level context is determined. To determine high-level context, in some embodiments, the control circuitries 220 and/or may apply techniques, such as NLP, lexical chaining, and semantic understanding, to various categories, such as historical texts, posts, emails, current chats etc. to determine the high-level context. Other techniques may be used and applied to categories, such as historical texts, posts, emails, current chats etc. to determine the high-level context. Some exemplary categories on which the techniques may be applied, as well as sources from which data for such categories can be obtained, are discussed further in relation to the description of FIGS. 11 and 12. For example, sources may include content from messaging applications and social media posts to name a few. They may also include extended reality applications, emails, attached documents to emails and other messaging, and voice transcripts from calls and conference calls and other categories from FIGS. 11 and 12.

In some embodiments, the system may use the NLP technique to determine the commonly used “N-grams” in the categories. Such as commonly used “N-grams” in the user's historical texts, posts, emails, current chats etc. Based on the words derived from NLP processing, the control circuitries 220 and/or 228 may perform lexical chaining of the words, i.e., determine a relationship between the words, such as by using an AI algorithm. In some embodiments, the control circuitries 220 and/or 228 instead of or in addition to performing lexical chaining, may perform a deeper analysis using a semantic understanding technique, which may allow the control circuitries 220 and/or 228 to construct a knowledge graph showing the deeper relationship between words that goes a level beyond lexical chaining.

The lexical chaining or semantic understanding techniques may be applied to any one or more of the categories described in FIG. 11. For example, it may be applied to frequently used words and in this embodiment the control circuitry may access the user's messages, posts, and other content to determine which words were frequently used by the user. To do so, the control circuitries 220 and/or 228 may review messaging history (e.g., N-grams, typically unigrams, bigrams and trigrams and other emojis that the user has a tendency to use based on history). It may then identify high frequency N-grams, i.e., expressions or groups of words for which the user has a very high proclivity and determine that such words are commonly used words by the user and when they match with a gesture that is should be suggested to the user.

The application of the techniques, in some embodiments, allows the control circuitry to determine the context of a conversation, text, post etc. Once the context has been determined, the control circuitries 220 and/or 228 may access a specific database that relate to the context to enhance a word list. For example, if the context determined is baseball, then the control circuitries 220 and/or 228 may access a baseball database or a national major league baseball website to obtain additional terms that relate to baseball. The control circuitries 220 and/or 228 may also query several databases to obtain baseball related terms. Once additional words from context specific databases are obtained, the control circuitries 220 and/or 228 may add those words to a high priority list (HPL). In other embodiments, the control circuitries 220 and/or 228 may remove or supplement some existing terms with the context specific words as needed.

At block 510, the control circuitries 220 and/or 228 may access the generated HPL and at block 515, the control circuitries 220 and/or 228 may blend the HPL with lexicon. As mentioned earlier, the blend may result in a blended list that includes words both from the lexicon as well as the HPL. The control circuitries 220 and/or 228 may then store the blended list in a database, such as the word database 420 in FIG. 4.

Use of the blended list, instead of only the lexicon without context, allows the control circuitries 220 and/or 228 to match a gesture with a suggested word with a higher probability because having the context the control circuitries 220 and/or 228 is able to suggest words that align with the user's intent rather than suggesting words that may not be the user's intent. For example, words and the order that may have been suggested purely based on a lexicon and without context are displayed in scenarios A-C in FIG. 7, and once context, probability of match, and rank order based on probability is used, then the system may improve word suggestions based on other data in addition to the gesture input.

At block 520, the control circuitries 220 and/or 228 may receive a user gesture. The gesture may be a) a hand or finger movement across a displayed keyboard whose trajectory is determined of b) a gaze movement in an extended reality application that displays a virtual keyboard (such as the keyboard in FIG. 6B) and has the ability to track a user's gaze, c) or console movement across a displayed keyboard, such as a Netflix™ keyboard displayed on a television screen, or across a virtual keyboard that is visible via am extended reality headset. Although some examples of gestures are described above, the embodiments are not so limited and any other gesture across a displayed keyboard where the gesture is intended for its application to provide a suggested word is also contemplated.

At block 525, the probability of each HPL word in the blended list that is a possible match to the gesture is increased. One method of increasing the probability includes the control circuitries 220 and/or 228 matching the gesture to a certain word in the blended list by either adding a constant offset or multiplying the initially obtained probability by a factor. The probability of matching to a certain word in the blended list may also use other polynomial functions. As such, the initially obtained probability for a word on this list based on gesture match, P(w)=X is processed by a transfer function f(X), such that f(X)≥X, making P(w)=f(X). By doing so, the word suggestion is enriched by the context data. For example, the control circuitries 220 and/or 228 by applying the techniques to any of the categories as described in block 102, may determine that the gesture is aimed at the word “batter,” which is contextually related to baseball. As such, the control circuitries 220 and/or 228 may enrich the lexicon by adding baseball terms to the HPL, such as “batter”, “pitcher”, “strike”, “home run” etc. Then, even if the initial probability of deriving a match with the word “batter” is lower than the words “Battery”, “Barter” or “Bare”, (as depicted in scenario B of FIG. 7), the control circuitries 220 and/or 228 may apply f(X) to the initially derived probability for “batter”, and blending the HPL with lexicon to generate a blended list, making words in the HPL list be a higher probability match to the gesture than the other words that are not related to the context. In this manner, the control circuitries 220 and/or 228 may suggest “Batter” as the highest probability match.

The words in the blended list are ranked and arranged based on their probability of match to gesture, such as in a descending order from the highest probability two of the lowest probability. Other types of arrangements are also contemplated.

In some embodiments, the control circuitries 220 and/or 228 may suggest a word from the blended list that ranks the highest on the probability scale. In other embodiments, the system may be configured to suggest more than one word at a time where the words suggested are the highest probability match to the gesture, typically presented in descending rank order. For example, the system may be configured to suggest three of the highest probability words at a time.

In some embodiments, once a word has been suggested, the control circuitry may automatically input the word into the display of the application. For example, if the user is using a WhatsApp™ application, the control circuitry may automatically input the suggested word into the typing box (such as typing box 630 in FIG. 6A) where the user composes a message. In other embodiments, the control circuitries 220 and/or 228 may input the suggested word into the typing/composing box once the user has provided their approval of the suggested word.

At box 530, a determination may be made by the control circuitries 220 and/or 228 whether in a previous iteration, i.e., a previous gesture, if suggested word, or words, were accepted by the user.

If a determination is made that the previously suggested word was accepted by the user, then at block 550, the control circuitries 220 and/or 228, for the current gesture, may suggested a word, or set of words, from the blended list that are rank ordered based on their probability of match to the current gesture.

On the other hand, if a determination is made that in the previous iteration, i.e., a previous gesture, if suggested word, or words, were not accepted by the user, that may trigger a calculation of a similarity index. In other words, if a determination is made that the user has not accepted the suggested word, or set of words, in the previous gesture, then the similarity index calculation is performed to ensure that words that were previously rejected for same/similar gesture as current gesture are not re-suggested to the user, since those were already rejected previously.

In some embodiments, at block 535, the control circuitries 220 and/or 228 may calculate a similarity index. To calculate a similarity index, the control circuitry may compare a current gesture performed by the user to a previous gesture to determine whether the user is trying to repeat a previous gesture in an attempt to get better suggested words and put that into the application. In other words, is the user retrying the same gesture again in an attempt to get the system to provide a suggested word that more accurately matches their intent, which depends on gesturing and context.

To determine whether sequential gestures are similar, the control circuitries 220 and/or 228 may describe the gesture input used for word matching as a function of: G=f(Tl, tl) where Tl, is the trajectory (Set of ordered pairs of Angle from a reference axis and length of line segment of swipe, i.e., {(Angle1, Length1), (Angle2, length2), . . . }) and tl may be the time spent at each identified break. In some embodiments, the control circuitries 220 and/or 228 may identify a curve in a trajectory, however in the other embodiments, an assumption may be made that a curve is “piecewise linear”, i.e., a set of line segments.

The control circuitries 220 and/or 228 may calculate a similarity index between the previous trajectory that a user has implicitly rejected (by choosing to re-input gesture input) and the current trajectory (such as for the last 2 attempts). To calculate this index, the control circuitries 220 and/or 228 may compare the trajectory, but not the time spent on each letter. Since a user in an attempt to retype, the word may enter a gesture at a different speed across multiple attempts to try the same word if they are not being successful. Not accounting for the speed, the trajectory similarity index may, in some embodiments, be calculated by the control circuitries 220 and/or 228 by developing a cumulative measure of the distance between 2 trajectories.

In some embodiments, when the cumulative measure of distance between 2 trajectories is high, then the similarity index may yield a low value, which is reflective of the similar gestures being different and as such are far apart in distance on the keyboard as determined by their trajectories.

On the other hand, when the cumulative measure of distance between two gestures is low, the similarity index is high, attaining the value 1 in the limit, which is reflective of the similar gestures being same and as such are close in distance on the keyboard as determined by their trajectories.

In some embodiments, If the similarity index between 2 successive user gesture typing attempts is above a threshold value, then the 2 trajectories are determined to be the same. If the 2 successive trajectories are determined to be the same, and the user did not accept any suggested word from the matches suggested in the first attempt, the control circuitries 220 and/or 228 may remove the words suggested in the earlier attempt from the set of possible matches to display to the user, i.e., the blended list resulting from the gesture.

The control circuitries 220 and/or 228 may then generate a new blended list without the previously suggested words. The new list of blended words is generated because the trajectory of current gesture deviates, even if slightly, from the previous gesture altering either the rank order of best matched words, or the words themselves. The new blended list may include some of the same words from the blended list for the previous gesture, which stands to reason because the similarity between the previous gesture and the current gesture was determined to be high.

Regardless of whether the two blended lists of the previous and current gestures are same or different, the control circuitries 220 and/or 228 may remove words previously suggested, since they were already rejected by the user, and ensure that the new blended list does not include the previously rejected words. The control circuitries 220 and/or 228 may suggest words from the newly generated blended list that was generated for the current gesture and rank the words in the blended list based on their probability rank ordering to match the current gesture. The highest-ranking words may then be presented to the user as suggestions.

In some embodiments, if the control circuitries 220 and/or 228 do not have the right context (yet), such as in a real time chat, and the system determines that the user is re-attempting gesture typing the same word (they ignored the word suggestions of the first attempt, AND the similarity index of the second attempt with the first attempt is high), it rejects/ignores the words that were presented in the previous attempt and suggest words from a blended list generated for the current gesture.

Once the similarity index is calculated, at block 540, the control circuitries 220 and/or 228 may compare the calculated similarity index to a threshold. The threshold may be a value set by the system, such as a percentage or a numerical value, or it may be a degree of similarity, such as low, medium, high. Other values, degrees, and categories of threshold may also be used.

If a determination is made at block 540 that the similarity index is above a threshold, then the control circuitries 220 and/or 228, at block 545, may suggest new words from the blended list after the words from previous gesture's blended list that were rejected are removed. For example, if the system has been configured to suggest three words at a time, then at block 545 the control circuitries 220 and/or 228 may suggest the highest ranked three words from a current blended list, which do not include the previously rejected words.

At block 540, if a determination is made that the similarity index is below the threshold, then the control circuitries 220 and/or 228, at block 550, may suggest words from the blended list based on their rank ordering of probability to match the entered current gesture, without removing any words.

FIG. 6A is an example of text typed into a messaging application of an electronic device, in accordance with some embodiments of the disclosure. As depicted in FIG. 6A, messaging applications 610, which may be WhatsApp™, and 640, which may be ShapeWriter™ may be used by a user to compose a message.

The messaging application, WhatsApp 610, may include a composing or typing area or box 630, an area where prior exchanges messages of the current chat are displayed 615, and a displayed keyboard 635. The application 610 may allow a user to place their finger on the displayed alphabet keyboard 635 and drag their finger across the keyboard in an attempt to input a word into the composing or text box 630. Rather than having to type out each word, the user may be able to drag their finger along a path or trajectory that spells out the word that they intend to be inputted into the composing or text box 630. As depicted, the user's trajectory 620 in the application may be an attempt by the user to input the word hotter onto the composing or text box 630. Likewise, as shown in a different application, shape writer 640, the trajectory 625 maybe an attempt by the user to input the word fun into the composing or text box area.

The embodiments and the processes described herein allow the control circuitries 220 and/or 228 to determine the highest probability words for the gestures 620, 625, and 650 in FIGS. 6A and 6B. To determine the suggested words, context is determined and used to generate a HPL and blend the HPL with the lexicon, and rank the words based on their highest probability match to the gesture while increasing the probability of the HPL words, as described in FIGS. 1 and 5.

FIG. 6B is an example of composing text in an extended messaging application by using the gaze of a user directed at the virtual keyboard. As depicted in FIG. 6B, a user wearing an extended reality headset may focus their gaze on a virtual keyboard displayed by an application that is running on the extended reality headset. Using their gaze or a controller, such as the controller 670, the user may be also to provide a gesture to an extended reality system that is capable of monitoring a user's gaze or movements of the controller. As the user moves their gaze or the controller, stopping momentarily at letters in the word, their trajectory 650 may be captured by the system to then match it with suggested words that can be inputted into the application. To determine the suggested words, context is determined and used to generate a HPL and blend the HPL with the lexicon and rank the words based on their highest probability match to the gesture while increasing the probability of the HPL words, as described in FIGS. 1 and 5.

FIG. 7 depicts examples of word suggestions based on gestures received, in accordance with some embodiments of the disclosure. The scenarios described in FIG. 7 represent an attempt to match a user's gesture and suggest words. For example, in scenario B 720, based on the user's gesture, and by only using a lexicon, a first set of words 721 that may be suggested including barter, battery, and matter (although the intent of the user may be for the application to recognize their gesture and suggest the word: batter). If the user does not accept the first set of words, the next set of words, or the second set of words 722 suggested may include battery, barter, <battery icon image>. If the user does not accept the second set of words, the next set of words, or the third set of words 723 suggested may include Nate, Bare, Bate. If the user does not accept the third set of words, the next set of words, or the fourth set of words 723 suggested may include barter, battery and batter. As depicted, without context and HPL, e.g., without using the processes of FIGS. 1 and 5, using only the lexicon may require many iterations for the system to finally suggest a word that matches the gesture entered by the user, depending on the user's input noise and the set of confounding words.

Using the processes of FIGS. 1 and 5, and embodiments described in the figures herein, the control circuitries 220 and/or 228 are able to generate a HPL based on context, rank order the words based on probability of match to the gesture while increasing the probability of the HPL words, and suggest the word Batter, in the above example, in the first iteration.

Similar to Scenario B, in Scenario C 730 a user may have provided a gesture, such as a gesture in FIG. 6A or 6B, by dragging their finger across the keyboard in an attempt to input a word into the composing or text box 630. In this scenario 730, the user may have inputted a gesture that was aimed at the word “hotter.” AS it can be seen at block 730, based on the user's gesture, and by only using a lexicon, it took several attempts, 16 in this illustrative example, for the system to suggest the word hotter. It can also be noticed that through various suggestions at various iterations, several words were repeatedly suggested to the user, such as the word hope, good, and how. Using the processes of FIGS. 1 and 5, and embodiments described in the figures herein, the control circuitries 220 and/or 228 are able to generate a HPL based on context, which in this case may be weather, rank order the words based on probability of match to the gesture while increasing the probability of the HPL words, i.e., contextually related words, and suggest the word Hotter, in the above example, in the first iteration.

FIG. 8 is an example of various natural language processing methods for determining high-level context of a communication, in accordance with some embodiments of the disclosure. These methods include tokenization 810, sentence breaking 820, lexical chaining 830, semantic understanding 840, and chunking 850. Other NLP methods in addition to those depicted may also be used. Using the methods, a context of the words, a relationship between the words, and a deeper understanding of the knowledge tree can be assessed. Such context, relationships, and deeper understanding are then used by the control circuitries 220 and/or 228 to generate the HPL and follow the steps of processes in FIGS. 1 and 5 to provide better suggested words that may yield a higher probability match to the user's intent.

FIG. 9 is a knowledge graph of words relating to a context, in accordance with some embodiments of the disclosure. In one embodiment, NLP may use semantic understanding as a method to determine a deeper relationship between words such that the deeper relationship can be used to determine context. To do so, in one embodiment, the control circuitries 220 and/or 228 may use an AI algorithm to determine relationships or cross-reference knowledge graphs available to the system. Employing knowledge graphs as cross-references for words selected from messaging chats or social media posts provides a deeper relationship understanding between words that goes a level beyond lexical chaining and is useful in determining a context.

As depicted, in this example, a deeper relationship between sports 910 is available to the NLP system to determine context. Here, the control circuitries 220 and/or 228 determined relationships between two separate sports basketball 920 and baseball 960. The control circuitries 220 and/or 228 further determined that words 3-pointer 930, double dribble 940, and Danny Ainge—who was a basketball player, is related to basketball 920. The control circuitries 220 and/or 228 also determined that words shortstop 970 and Danny Ainge—was a baseball player, is related to baseball 960. The control circuitries 220 and/or 228 further determined that Danny Ainge played both baseball and basketball and as such is related to both. Accordingly, if the context of the communication in which the gesture is received is determined to be either baseball or basketball, the control circuitries 220 and/or 228 would suggest the word Danny Ainge when it matches the gesture. Without such context, using only a lexicon, Danny Ainge would not be suggested.

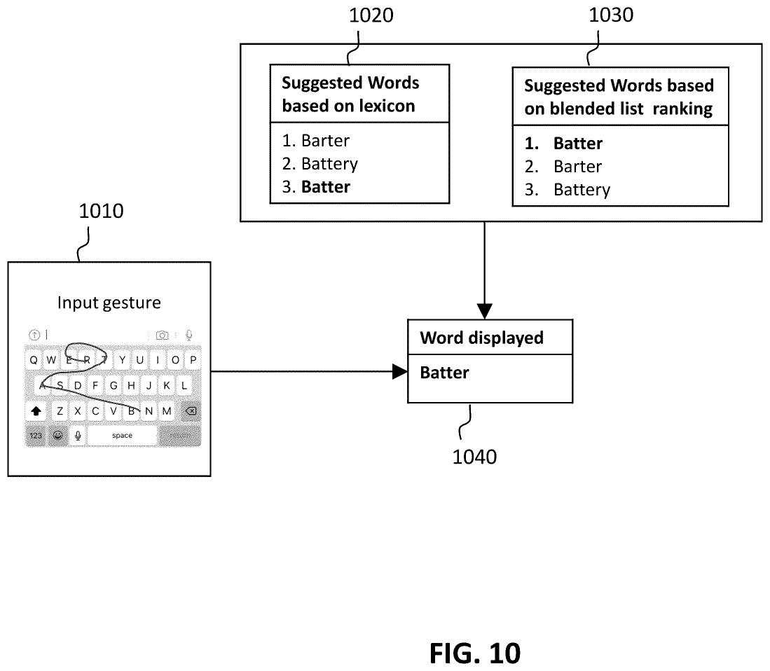

FIG. 10 is an example of decreasing rank order of the probability of matching a word, given an input gesture, in accordance with some embodiments of the disclosure. In this embodiment, context is determined and a HPL is generated based on the determined context, such as by using the process of blocks 102 and 103 in FIG. 1 and/or blocks 505-515 in FIG. 5. In this embodiment, the context determined by the control circuitry is baseball. The figure depicts the control circuitries 220 and/or 228 receiving gesture 1010. Based on the gesture received the three words that may have been suggested based on lexicon are shown in block 1020. However, since a HPL that is blended with the lexicon is applied, in which the words are rank ordered based on the probability of matching the gesture while increasing the match probability of the HPL words, the control circuitries 220 and/or 228 may change the ordering of the words and rank them as displayed at block 1030. The control circuitries 220 and/or 228 may then suggest and display the word “batter” at block 1040. In other embodiments, where the system is configured to display more than one suggested word, such as two or three suggested words, the control circuitries 220 and/or 228 may display the top two or three rank ordered words for selection by the user and the selected word may be inputted into the application, such as a composing space of a messaging application or a post of a social media application.

FIG. 11 is a block diagram of potential types of contextual data categories used to improve gesture typing, in accordance with some embodiments of the disclosure. These are the contextual data categories, in some embodiments, on which techniques described in block 102 of FIG. 1 are applied to determine high level context. The sources from where data relating to contextual data categories can be obtained, in some embodiments, are depicted in FIG. 12. Although certain contextual data categories and sources from where they can be obtained have been described through FIGS. 11 and 12, the embodiments are not so limited. Additional data categories and sources are also contemplated. For example, data categories may include voice messages transcribed by voice to text service, data generated in a virtual application in which a user provides speech or comments, data relating to digital assistance, such as Siri™, Google Assistant™, or Amazon's Alexa™ can be obtained and transcribed to determine context as well as the user's preference of words.

In some embodiments, the contextual data category to select words for the HPL include frequently used words 1105. In this embodiment, for block 1105, the control circuitries 220 and/or 228 may access the user's messages, posts, and other written content to determine which words were frequently used by the user in the past. The control circuitries 220 and/or 228 may review messaging history (e.g., N-grams, typically unigrams, bigrams and trigrams and other emojis that the user has a tendency to use based on history) and may identify high frequency N-grams, i.e., expressions or groups of words for which the user has a very high proclivity.

In some embodiments, for block 1110, the control circuitries 220 and/or 228 may apply techniques to historical chats to determine the context. In this embodiment, NLP (and any of its methods such as lexical chaining and/or semantic understanding) may be applied to words that the user has used previously in their chats. The control circuitries 220 and/or 228 may obtain permissions to access the user's historical communication, including chats, such as to WhatsApp™, Viber™, Signal™, Facebook Messenger™, Microsoft Teams™, Google Hangouts™ and other chatting applications. The control circuitries 220 and/or 228 after accessing the chats may then analyze the words used in those chats. The analysis, in some embodiments, may include performing a text analysis to determine context of the last several messaging conversations between the user and the other recipients or correspondent(s) of the current or previous conversation. The control circuitries 220 and/or 228 may then create a list of relevant words based on the semantic knowledge, such as the knowledges graph depicted in FIG. 9.

In some embodiments, for block 1115, the control circuitries 220 and/or 228 may apply techniques to current communications or current events to determine the context. For example, the control circuitries 220 and/or 228 may apply the techniques (such as NLP) to conversations within a predetermined period of time, such as within last 30, 17, 10, or another predetermined number of days. The control circuitries 220 and/or 228 may also restrict the analysis of determining context to only those conversations relate to a specific or current event. Historical chats and other data categories in FIG. 11 may also be limited to such data that relates to current communication or a current event.

In some embodiments, for block 1120, the control circuitries 220 and/or 228 may apply techniques to communications by the user on the same topic with any recipients or individuals in a group chat (as depicted in 1125) to determine the context. In this embodiment, the techniques (such as NLP, including lexical chaining and/or semantic understanding) may be applied to a text, chats, posts or any other communication between a current user and any recipient or a group chat in which the user is a participant, that relates to the same topic. For example, of the topic relates to a player (Stephen Curry's) performance in the 2021 NBA™ finals and the user is a participant in that group, text, chats, posts or any other communication can be used as a contextual data category to apply the techniques. Likewise, if the user chats with another recipient, not in a group chat, who is not part of a current conversation and the topic relates to a player (Stephen Curry's) performance in the 2021 NBA™ finals, which is determined to be the same topic in the current conversation, then text, chats, posts or any other communication from the other communication on the same topic can be used as a contextual data category to apply the techniques.

In some embodiments, for block 1130, the control circuitries 220 and/or 228 may gather data relating to a relationship between the user and the recipients. Such relationship may be stored in the user's profile, e.g., John is user's dad etc. The relationship may also be determined based on previous conversations, social media posts, and other communications between the user and the recipient. In some embodiment, an AI engine executing an AI algorithm may analyze communications between user and recipient and determine a relationship. Determining relationship may assist the control circuitries 220 and/or 228 in determining which words may or may not be appropriate based on the recipient. It may also allow the control circuitries 220 and/or 228 to determine context of certain topic, such as daughter-mother that frequently discuss a certain topic and if a gesture is to be inputted when a gesture is received from a daughter in a message that is being composed for her mother, the control circuitries 220 and/or 228 may use previously used words between them.

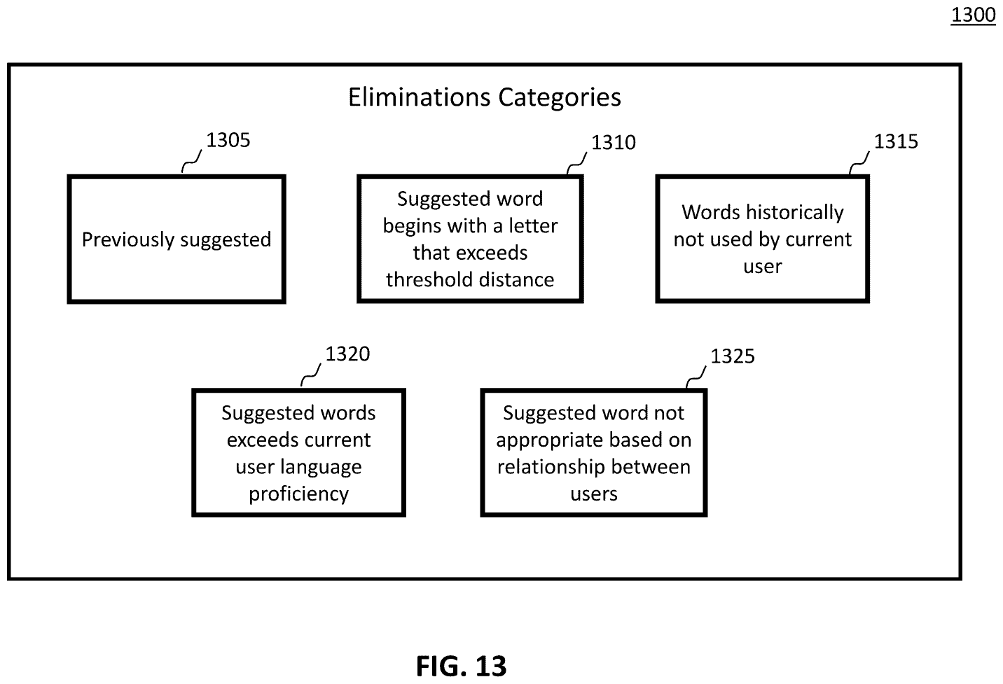

FIG. 13 is a block diagram of potential elimination categories used to eliminate words that may not be a good suggestion for the current user, in accordance with some embodiments of the disclosure. These are potential categories of words that may be eliminated from being suggested to the user based on prior user actions, such as user not accepting any suggested word from the previously attempted gesture.

In one embodiment, the control circuitries 220 and/or 228 may not suggest a word, or set of words, that were previously suggested to the user, as depicted at block 1305. In this embodiment, a user may have been presented a word or a set of words that had the highest probability rank in the blended list that matched the user's gesture. If the user does not accept the suggested words, or actively rejects the suggested words, then based on the determination that the user had not accepted (or rejected) any of the previously suggested words, the control circuitries 220 and/or 228 may prevent suggesting the same words to the user when a subsequent gesture that is similar to the previous gesture is received. Instead, the control circuitries 220 and/or 228 may present the words from the new list, by removing the previously rejected words in the rank ordering based on probability of matching the gesture and presenting the top matches from the remaining list.

In another embodiment, the control circuitries 220 and/or 228 may not suggest a word, or set of words, that begin with a letter that exceeds the threshold distance, as depicted at block 1310. For example, awful and terrible may have a similar meaning. On a QWERTY keyboard, the letter A (in awful) is four letters across horizontally and 1 letter across vertically to the letter T (in terrible). The control circuitries 220 and/or 228 may measure this distance in terms of number of letters horizontally and vertically away from each other to calculate a distance between the starting letters of each word. In one embodiment, a threshold may be set at distance of 3 letters apart, i.e., that the starting letter of a word that is to be suggested cannot be greater in distance that two letters from the starting point of the gesture. In this embodiment, since a suggested word “awful” is 4 letters across and 1 letter vertically far from a gesture that starts from the letter “T”, i.e., exceeding the distance threshold of 3 letters, awful will not be suggested.

In another embodiment, the control circuitries 220 and/or 228 may not suggest a word, or set of words, that the user has not used historically, as depicted at block 1315. In this embodiment, control circuitries 220 and/or 228 may utilize a machine learning (ML) algorithm to determine which words have been used by the user in their previous chats, posts, emails, and other written text. Such data may be used and compared to a current gesture to determine whether it matches to a word that has or has not been historically used by the current user.

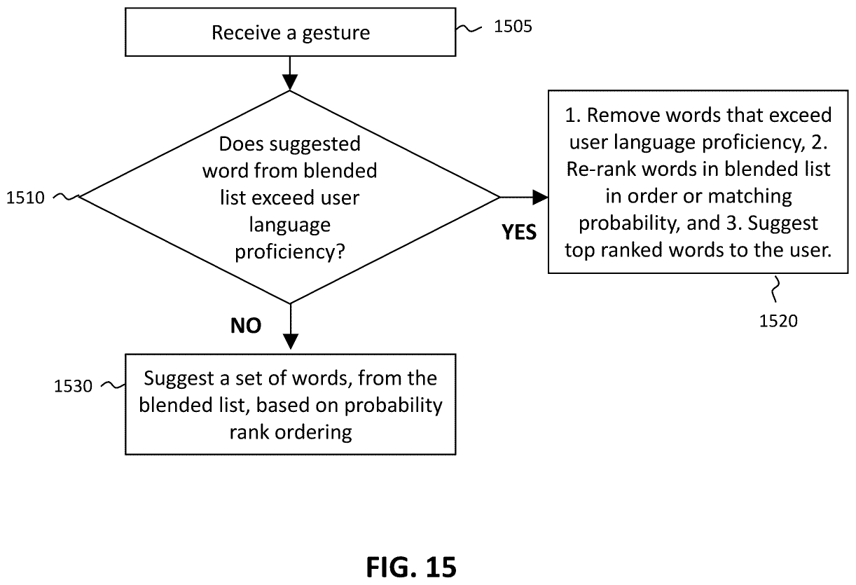

In another embodiment, the control circuitries 220 and/or 228 may not suggest a word, or set of words, that the exceeds the user's language proficiency, as depicted at block 1320. In this embodiment, control circuitries 220 and/or 228 may use several methods to determine a user's language proficiency, such as use and ML algorithm to obtain data related to the user's previous text, post, and other written text, and then use an AI algorithm to analyze the text and determine the user's language proficiency. The control circuitries 220 and/or 228 may then use language proficiency in suggesting a word to the user. More details of the process for using the user's language proficiency are described in relation to the description of FIG. 15.

In another embodiment, the control circuitries 220 and/or 228 may not suggest a word, or set of words, if the control circuitries 220 and/or 228 determines that such usage is not appropriate based on the user's relationship with the recipient of the message, as depicted at block 1325. In this embodiment, the control circuitries 220 and/or 228 may determine a relationship between the user composing the message in a messaging application and the recipient of that message. Such relationship may be stored in the user's profile, e.g., John is user's dad etc. The relationship may also be determined based on previous conversations, social media posts, and other communications between the user and the recipient. In some embodiment, an AI engine executing an AI algorithm may analyze communications between user and recipient and determine a relationship.

Once the relationship is determined, if any of the words on the HPL are not appropriate for the relationship, such as profanity, adult language, sex-oriented words and they are being used to a recipient who is the user's mother, father, or child, the control circuitries 220 and/or 228 may flag such words such that they may be removed from the suggestion list of words. The user or AI system may also generate rules on what types of words are not appropriate based on the relationship. For example, certain words may not be suitable when the recipient is your boss at work or a colleague but may be suitable if you are texting a close friend.

Although some categories of elimination are described in FIG. 13, the embodiments are not so limited and other categories are also contemplated. The user may also generate a list of categories or rule of what type of words to remove from being suggested.

FIG. 14 is a flowchart of a process for determining similarity between repeated gestures and eliminating previously suggested words based on the determination, in accordance with some embodiments of the disclosure. In this embodiment, the control circuitries 220 and/or 228 at block 1 may have determined that the context related to the current conversation is baseball. The determination of the context may be performed by using the process of block 102 in FIG. 1 and/or blocks 505 in FIG. 5.

At block 1, a current gesture (1405) may be received by the control circuitries 220 and/or 228.

At block 2, the control circuitries 220 and/or 228, in one embodiment, may configure the system to suggested 3 words at a time to the user. The number may vary, and the system may be configured to display another configured number of suggested words at a time. Limiting the number of suggested words to a minimum, such as 1-5 words at a time, in one embodiment, may help a user visually review a few words at a time and be able to select a suggested word from the number of words suggested. Block 2 configuration may occur at any time, including prior to receiving the current gesture at block 1, or it may be a system-defined parameter.

At block 3, a determination may be made by the control circuitries 220 and/or 228 that the user did not select any of the suggested words in a previous gesture. The control circuitries 220 and/or 228 may have stored in memory that words 1, 2, and 3 were suggested previously based on the previous gesture and also that none were chosen by the user. The control circuitries 220 and/or 228 may also determine that 3 words were suggested based on the system configuration to suggest three words at a time and the 3 words suggested were the highest ranked words based on probability of match to the previous gesture.

At block 4, in one embodiment, because the control circuitries 220 and/or 228 determined that no words that were suggested for the previous gesture were selected, this triggered a similarity index calculation to determine whether the previous gesture was similar to the current gesture. One of the benefits of performing the gesture similarity comparison when previously suggested words are not accepted is to prevent suggesting the same words over and over again and frustrating the user by re-suggesting words that the user has already rejected.

The similarity index calculation compares the current gesture to the previous gesture to determine whether they are similar. In other words, was the user intending to repeat a gesture because the words suggested did not match the previous gesture to the user's liking or intent.

In this example, performing the similarity analysis between the current gesture (1405) and previous gesture (1415), the control circuitries 220 and/or 228 may have determined that they are 88% similar to each other. The similarity analysis may include determining starting and ending points of both gestures, the path/trajectory taken, such as the curvature of the gestures, other letters crossed along the trajectory and any other data points relating to the trajectory captured by the system. The comparison of the gestures (without the keyboard in the background) is also displayed at 1420 for sake of clarity, however, the gestures are always performed on the keyboard.

At block 5, the control circuitries 220 and/or 228 may determine a threshold of similarity. This is a threshold that may be predetermined by the system. In this embodiment, the threshold may be set at 70%, however, the threshold may be set at any other percentage. In other embodiments, the threshold may be a value, a range, or some other quantifiable measure.

The control circuitries 220 and/or 228 measuring the similarity between the gestures with the threshold may determine that 88% similarity exceeds the 70% threshold. In other words, the two gestures are similar beyond the threshold. The threshold in some embodiments, allows for human error and deviation from earlier trajectory. Since a human intending to re-enter, the same gesture may perform hand or finger movements on the keyboard slightly different that how they performed previously (injecting input noise, e.g., due to fat finger, shaky hand, different speed of tracing) the control circuitries 220 and/or 228 evaluates such deviations to determine whether they are deviations from the earlier trajectory or a gesture that is aimed at a completely different word.

As it can be seen at 1420, the two gestures are fairly close in curvature and start and end points. As long as the similarity of gestures is above the threshold, the control circuitries 220 and/or 228 may consider them to be gestures relating to the same word. As such, the control circuitries 220 and/or 228, at block 6, generate a new list of words based on the rank order of the probability of matching the gesture. In this illustrative example, the best matches in descending rank order of probability of match are Word 3, Word 11 and Word 2 respectively. Further, based on the similarity to the previous gesture exceeding the threshold, the control circuitries 220 and/or 228, at block 6, may remove words that were previously suggested at 1410, i.e., Words 3 and 2. They may generate a new blended list from the remaining blended list after removing the previously suggested words. In this illustrative example, after Word 3 and Word 2 are removed, control circuitries 220 and/or 228 may present Word 11, Word 6 and Word 13 as the suggested words to the user.

It is to be noted that, in some examples, the blended list generated for the previous gesture may be different from the blended list generated for the current gesture even though the gestures are similar. This is because an algorithm to generate blended lists in which words are ranked based on their probability of their match to the gesture may be sensitive to even a small deviation in trajectory of the gestures. In other words, since the trajectories have some differences and are not an exact match, the blended lists generate may also be different to match those trajectories. In other examples, the blended list generated for the previous gesture and current gesture may be very similar, i.e., contain common words or same words in a different rank order.

Regardless of whether the two blended lists of the previous and current gestures are same or different, the control circuitries 220 and/or 228 may remove words 1-3, which were previously suggested to the user and not accepted from the current list. Doing so would ensure that words not accepted by the user for similar gesture are not suggested again. Having the previously suggested words removed, the control circuitries 220 and/or 228 may suggest new words based on their probability rank ordering to match the current gesture as depicted at 1430 and 1435.

FIG. 15 is a flowchart of a process for determining language proficiency and revising rank ordering of words in the HPL based on the determined language proficiency, in accordance with some embodiments of the disclosure. In some embodiments, there may be reasons why a certain word, or words, may not be suggested to the user. As described in FIG. 13, these reasons include, but are not limited to, words that were previously suggested (and not accepted by the user), words that begin with a letter that is above a threshold distance (e.g. far from the starting point of the gesture), words historically not used by the current user, words that are not appropriate based on the relationship between the current user and the recipient, and words that exceed the user's language proficiency.

In this embodiment, a process of eliminating words that exceed the user's language proficiency, as depicted in block 1320 of FIG. 13, is described. At block 1505, a gesture, such as the gestures 620, 625, or 650 depicted in FIGS. 6A and 6B is received by the control circuitries 220 and/or 228.

Upon receiving the gesture, the control circuitries 220 and/or 228 may suggest word, or words, from the blended list based on the received gesture. These words in the blended list may be rank ordered based on their probability of match to the received gesture.

In this embodiment, the control circuitries 220 and/or 228 may make a further determination, such as at block 1510, whether the suggested words are within the user's language proficiency or if they exceed the user's language proficiency. Such language proficiency may be determined based on prior messages, emails, text, or any other written content by the user and analyzed using a machine learning and/or an AI algorithm. It may also be a user input, such as a ranking on a scale of 1-10, or it may be developed based on administering a language proficiency test.

If a determination is made at block 1510 that the words in the blended list exceed the language proficiency of the user, then at block 1520 the control circuitries 220 and/or 228 may 1) remove such words, 2) re-order the list to only include the words that are within the user's language proficiency, and 3) present the top ranked words to the user. In some embodiments, the control circuitries 220 and/or 228 may revise the ranking of the words in the blended list such that the probability of matching of words that are not within the user's language proficiency is reduced using a transfer function, such as the transfer function described in relation to block 525 of FIG. 5. Thus, ranks of these words in the list are adjusted down, to give higher rank to the words that are within the user's language proficiency on a relative basis. Upon re-ranking, the control circuitries 220 and/or 228 may suggest the word that is highest in the priority rank to the user.

If a determination is made at block 1510 that the words in the blended list are within the language proficiency of the user, then at block 1530 the control circuitries 220 and/or 228 may suggest these words as the best matches in rank order of descending probability.

Some of the embodiments that have been described above are mentioned again below. As mentioned above, the embodiments using control circuitries 220 and/or 228 generate a blended list of words when a gesture is received. The blended list of words is a blend of a high-priority list of words (HPL) determined based on a context, and a lexicon. The blended list is generated in response to a receiving a gesture in an application. Each separate gesture will generate a new blended list. The gesture corresponds to a navigation of a path on a displayed digital keyboard of the application. This path is based on a user tracing their finger on the displayed digital keyboard and stopping at certain letters along the path. The control circuitries 220 and/or 228 may suggest a word from the blended list of words that corresponds to the received gesture and display the suggested word on the display of the electronic device on which the application is running.

Stated in another manner, the embodiments include receiving a gesture in an application, wherein the gesture corresponds to a navigation of a path on a displayed digital keyboard of the application, displaying a suggested word corresponding to the received gesture, where selecting the suggested word for display comprises generating a blended list of words for the received gesture, wherein the blended list of words is a blend of a) high-priority list of words (HPL) determined based on a context and b) a lexicon, rank ordering words in the blended list of words based on their probability of match to the received gesture, and selecting one or more highest ranked word, from the rank ordered words in the blended list, as the suggested word.

The embodiments relating to generating the blended list of words comprise, the control circuitries 220 and/or 228 applying a natural language processing (NLP) technique to a category of words, such as the categories described in FIG. 11. The control circuitries 220 and/or 228 determines a high-level context based on applying the NLP technique and based on the determined high-level context access a context specific database to obtain context specific words from the context specific database. This can be from a context specific database as shown at block 450 in FIG. 4. The embodiments generate the HPL with words from the context specific database and words from the lexicon. Once this is generated, the embodiments, blend the HPL with the lexicon to generate the blended list of words.

In some embodiments, suggesting the word from the blended list of words comprises increasing a probability of those words in the blended list that are associated with the HPL that correspond to the received gesture. Once the probability of those words is increased, they are rank ordered based on the increased probability and suggested based on the rank ordering. For example, the suggested word is a word that is ranked with the highest probability. In another example, a second word is suggested, after suggesting the word with the highest probability or in conjunction with the word with the highest probability. The second word that is ranked second in probability after the suggested word may be the word suggested.

As mentioned above, in some embodiments, the HPL includes words that are context specific. In another embodiments, the HPL includes words that were used above a threshold frequency in prior communications that occurred using the application of the electronic device. In yet another embodiment, the HPL includes words that were used in prior communications between a same sender and recipient of the communication. In another embodiment, the HPL includes words that were previously used in a current communication. Further, in some embodiments, the HPL includes words that were used in prior communications by a user for communications relating to a same context. Other embodiments that relate to the type of words in the HPL are described throughout the application and the embodiments mentioned are not limited.

In some embodiments, the application in which a gesture is entered or received is a mobile messaging application and the communication is a message composed by a sender intended for a recipient. In another embodiments, the application is a social media application, and the communication is a post composed by a user. These are exemplary applications, and the embodiments are not so limited. The embodiments described apply to any application in which gesturing to enter a word is enabled where the gesture is received in response to a user touching a finger on the displayed digital keyboard of the application and moving the finger along a path on the displayed keyboard, wherein the keyboard includes icons, letters of an alphabet (including in all languages), symbols, or any other text or graphical feature. The path mentioned, in some embodiments, includes a starting location and an ending location, wherein the starting and ending location are letters of the alphabet.

The gesture may also be received, in some embodiments, in response to a user gaze directed at displayed letters of the alphabet of the displayed digital keyboard of the application. In this context, such as in an AR/VR or metaverse setting where gaze is used to enter a word, the embodiments may determine a starting location, an ending location, and a path from the starting to the ending location of the gaze, to determine the gesture.

In some embodiments, a current gesture in an application is received. As mentioned above, the gesture is related to trajectory of a hand movement on a displayed digital keyboard related to the application. Upon receiving the gesture, in some embodiments, a determination is made that all words suggested in a gesture previous to the current gesture were rejected. As such, in response to the determination, in some embodiments, determination of whether a similarity index is above a threshold is performed. If the similarity index is above the threshold then the embodiments generate a blended list of words for the current gesture, where the blended list of words is a blend of a high-priority list of words (HPL) determined based on a context, and a lexicon associated with an application, wherein the generated blended list of words does not include the words rejected in the gesture previous to the current gesture if the similarity index is above the threshold. The highest rank word or words from the blended list of words is then presented to the user.

The similarity index relates to a similarity between the current and previous gestures. In some embodiments, the trigger for determining similarity index is based on a determination the word suggested in the gesture previous to the current gesture (or all words if more than one was suggested) was rejected.

In some embodiments, a determination is made that one or more highest ranked words exceeds a language proficiency level of a user. As such, the embodiments remove the one or more highest rank words from the blended list based on the determination. In some embodiments, determining that the highest ranked was not previously used by a user result in removing the highest ranked word from the blended list based on the determination.

It will be apparent to those of ordinary skill in the art that methods involved in the above-described embodiments may be embodied in a computer program product that includes a computer-usable and/or -readable medium. For example, such a computer-usable medium may consist of a read-only memory device, such as a CD-ROM disk or conventional ROM device, or a random-access memory, such as a hard drive device or a computer diskette, having a computer-readable program code stored thereon. It should also be understood that methods, techniques, and processes involved in the present disclosure may be executed using processing circuitry.

The processes discussed above are intended to be illustrative and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
generating a blended list of words, wherein the blended list of words is a blend of a high-priority list of words (HPL) determined based on a context, and a lexicon;
in response to a receiving a gesture in an application, wherein the gesture corresponds to a navigation of a path on a displayed digital keyboard of the application: suggesting a word from the blended list of words that corresponds to the received gesture; and displaying the suggested word on a display of the electronic device.

2. The method of claim 1, wherein generating the blended list of words further comprises:
applying a natural language processing (NLP) technique to a category of words;
determining a high-level context based on applying the NLP technique;
accessing a context specific database based on the determined high-level context to obtain context specific words from the context specific database;
generating the HPL with words from the context specific database and words from the lexicon; and
blending the HPL with the lexicon to generate the blended list of words.

3. The method of claim 1, wherein suggesting the word from the blended list of words further comprises:
increasing a probability of those words in the blended list that are associated with the HPL that correspond to the received gesture;
rank ordering the words in the blended list based on the increased probability; and
suggesting the word based on the rank ordering.

4. The method of claim 3, wherein the suggested word is a word that is ranked with the highest probability.

5. (canceled)

6. The method of claim 1, wherein the HPL includes words that are context specific.

7. The method of claim 1, wherein the HPL includes words that are selected from any one of a) words that were used above a threshold frequency in prior communications that occurred using the application of the electronic device, b) words that were used in prior communications between a same sender and recipient of the communication, and c) words that were previously used in a current communication, and words that were used in prior communications by a user for communications relating to a same context.

8-10. (canceled)

11. The method of claim 1, wherein the application is a mobile messaging application, and the communication is a message composed by a sender intended for a recipient.

12. (canceled)

13. The method of claim 1, wherein the gesture is received in response to a user touching a finger on the displayed digital keyboard of the application and moving the finger along a path on the displayed keyboard, wherein the keyboard includes icons or letters of an alphabet.

14. (canceled)

15. The method of claim 1, wherein the gesture is received in response to a user gaze directed at displayed letters of the alphabet of the displayed digital keyboard of the application.

16. (canceled)

17. The method of claim 1, further comprising generating a new blended list of words for each new gesture received.

18. A method comprising:
receiving a current gesture in an application, wherein the gesture is related to trajectory of a hand movement on a displayed digital keyboard related to the application;
determining that all words suggested in a gesture previous to the current gesture were rejected; and
in response to the determination, determining whether a similarity index is above a threshold;
generating a blended list of words for the current gesture, wherein the blended list of words is a blend of a high-priority list of words (HPL) determined based on a context, and a lexicon associated with an application, wherein the generated blended list of words does not include the words rejected in the gesture previous to the current gesture if the similarity index is above the threshold; and
presenting a highest rank word or words from the blended list of words.

19. The method of claim 18, wherein the similarity index relates to a similarity between the current and previous gestures.

20. The method of claim 18, further comprising, triggering determining of the similarity index in response to determining that the word suggested in the gesture previous to the current gesture was rejected.

21. The method of claim 18, further comprising, determining that one or more highest ranked words exceeds a language proficiency level of a user, and removing the one or more highest rank words from the blended list based on the determination.

22-25. (canceled)

26. A system comprising:
communications circuitry configured to access a displayed digital keyboard of an application; and
control circuitry configured to:
generate a blended list of words, wherein the blended list of words is a blend of a high-priority list of words (HPL) determined based on a context, and a lexicon; and
in response to a receiving a gesture in an application, wherein the gesture corresponds to a navigation of a path on the displayed digital keyboard of the application: suggest a word from the blended list of words that corresponds to the received gesture; and displaying the suggested word on a display of the electronic device.

27. The system of claim 26, wherein generating the blended list of words further comprises, the control circuitry configured to:
apply a natural language processing (NLP) technique to a category of words;
determine a high-level context based on applying the NLP technique;
access a context specific database based on the determined high-level context to obtain context specific words from the context specific database;
generate the HPL with words from the context specific database and words from the lexicon; and
blend the HPL with the lexicon to generate the blended list of words.

28. The system of claim 26, wherein suggesting the word from the blended list of words further comprises, the control circuitry configured to:
increase a probability of those words in the blended list that are associated with the HPL that correspond to the received gesture;
rank order the words in the blended list based on the increased probability; and
suggest the word based on the rank ordering.

29. The system of claim 28, wherein the suggested word is a word that is ranked with the highest probability.

30-31. (canceled)

32. The system of claim 26, wherein the HPL includes words that are selected from any one of a) words that were used above a threshold frequency in prior communications that occurred using the application of the electronic device, b) words that were used in prior communications between a same sender and recipient of the communication, c) words that were previously used in a current communication, and words that were used in prior communications by a user for communications relating to a same context, and d) words that are context specific.

33-35. (canceled)

36. The system of claim 26, wherein the application is a mobile messaging application, and the communication is a message composed by a sender intended for a recipient.

37. (canceled)

38. The system of claim 26, wherein the gesture is received by the control circuitry in response to a user touching a finger on the digital keyboard of the application and moving the finger along a path on the displayed keyboard, wherein the keyboard includes icons or letters of an alphabet.

39. (canceled)

40. The system of claim 26, wherein the gesture is received by the control circuitry in response to a user gaze directed at displayed letters of the alphabet of the displayed digital keyboard of the application.

41. (canceled)

42. The system of claim 26, further comprising, the control circuitry configured to generate a new blended list of words for each new gesture received.
